(19) United States
(12) Patent Application Publication
(10) Pub. No.: US 2012/0211228 A1
(43) Pub. Date: Aug. 23, 2012

(54) Artificial Lift Modeling Methods and Systems

(76) Inventors: Andrey A. Troshko, Pearland, TX (US); David P. Yale, Milford, NJ (US)

(21) Appl. No.: 13/384,312

(22) PCT Filed: Jul. 9, 2010
(86) PCT No.: PCT/US10/41547

§ 371 Date: May 1, 2012

Related U.S. Application Data
(60) Provisional application No. 61/238,569, filed on Aug. 31, 2009.

(51) Int. Cl. E21B 43/12; G06F 7/60; E21B 43/16; G06F 17/10

(52) U.S. Cl. 166/305.1; 703/2; 166/53

(57) ABSTRACT

Methods for modeling, configuring, and controlling artificial lift processes are provided as well as systems for controlling artificial lift and hydrocarbon production systems. In particular, the methods and systems include the use of computation solid-liquid slurry models and reservoir inputs configured to provide inputs to configure parameters of an artificial lift system. The methods and systems may also incorporate fluid lift computational models and volume of fluid (VOF) models for verifying the numerical results. The disclosed methods and systems may beneficially be used in combination with hydrocarbon production processes such as fluidized in-situ reservoir extraction (FIRE) process; a SRBR process; an enhanced CHOPS process; and any combination thereof.

### CROSS-REFERENCE TO RELATED APPLICATION

This application claims the benefit of U.S. Provisional Patent Application 61/238,569 filed 31 Aug. 2009 entitled ARTIFICIAL LIFT MODELING METHODS AND SYSTEMS, the entirety of which is incorporated by reference herein.

### FIELD

Embodiments of the invention relate to methods of modeling artificial lift from a subsurface formation. More particularly, embodiments of the invention relate to methods and systems for modeling artificial lift systems using numerical analysis to more accurately predict reservoir behavior during production and injection of sand and fluids in a hydrocarbon recovery process.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

### Description of the Related Art

Bitumen is a heavy oil or tar with viscosity more than about 10,000 centipoise (cP) found in porous subsurface geologic formations. Bitumen is often entrained in sand, clay, or other porous solids and is resistant to flow at subsurface temperatures and pressures. Current recovery methods inject heat, viscosity reducing solvents, or some combination thereof, to reduce the viscosity of the bitumen and allow it to flow through the subsurface formations and to the surface through boreholes or wellbores. Some proposed methods include injecting highly viscous fluids (e.g. emulsions) into formations to displace oil having a viscosity of less than about 5,000 cP. Other methods breakup the sand matrix in which the heavy oil is entrained by water injection to produce the formation sand with the oil; however, the recovery of bitumen using water injection techniques is limited to the area proximal the bore hole. These methods generally have low recovery ratios and are expensive to operate and maintain. However, there are hundreds of billions of barrels of these very heavy oils in the reachable subsurface in the province of Alberta alone and additional hundreds of billions of barrels in other heavy oil areas around the world. Efficiently and effectively recovering these resources for use in the market is one of the world's toughest energy challenges.

Extracting bitumen from oil sand reservoirs generally leads to production of sand, limestone, clay, shale, bitumen, asphaltenes, and other in-situ geo-materials (herein collectively referred to as sand or particulate solids) in methods such as Cold Heavy Oil Production with Sand (CHOPS), Cyclic Steam Stimulation (CSS), Steam Assisted Gravity Drainage (SAGD), Slurrified Reservoir Bitumen Recovery (SRBR), and Fluidized In-situ Reservoir Extraction (FIRE). The amount of sand and water produced may vary from very small to large and it depends on the type of method, stress-state within the reservoir, drawdown and depletion. In cases of CSS and SAGD, sand production is not desirable. On the other hand, sand production is encouraged in cases of CHOPS, SRBR (see, e.g. U.S. Pat. No. 5,823,631), and FIRE (see, e.g. International Patent Application Publication WO2007/050180) processes. When the amounts of sand and water produced are very large, it is important to be able to safely dispose the sand and water back into subsurface. Feasibility, safety and optimization of such complex large scale production and disposal of materials require realistic simulation models.

What is needed are systems and methods for more accurately configuring, modeling, and controlling artificial lift systems and processes.

Additional references may be found in: 1. ACKERMAN N L, HUNG T S, Rheological characteristics of solid-liquid mixtures, A. I. Ch. E. Journal, 25 2, 327-332 (1997); 2. ARANSON I S AND TSIMRING L S, Patterns and collective behavior in granular media: Theoretical concepts, Reviews of modern physics, 78, 641-692 (2006); 3. CASSAR C, NICOLAS M POULIQUEN O, Submarine granular flow down inclined planes, Physics of Fluids, 17; 4. DARTEVELLE S, Numerical and granulometric approaches to geophysical granular flows, PhD thesis, Michigan Technological University (2003); 5. DODGE D W AND METZNER A B, Turbulent flow of non-Newtonian systems, A. I. Ch. E Journal, 5 2, 189-204 (1962); 6. FUJIMOTO H, NAGATANI T AND TAKUDA H, Performance characteristics of a gas-solid-liquid airlift pump, Int. J. of Multiphase Flows, 31, 1116-1133 (2005); 7. FUJIMOTO H, OGAWA S TAKUDA H AND HATTA N, Operation performance of a small air-lift pump for conveying solid particles, J. of Energy Resource Technology, 125, 17-25 (2003); 8. DE HENAU V, RAITHBY G D, A transient two-fluid model of the simulation of slug flow in pipeline I-Theory, Int. J. Multiphase Flow, 21 3, 335-349 (1995); 9. D. GIDASPOW, R. BEZBURUAH, AND J. DING, Hydrodynamics of Circulating Fluidized Beds, Kinetic Theory Approach, In Fluidization VII, Proceedings of the 7th Engineering Foundation Conference on Fluidization, pages 75-82, (1992); 11. HEYWOOD N I AND CHARLES M E, Effects of gas injection on the vertical pipe flow of fine slurry, Proc. Hydrotransport 7 Conf., Paper E1, BHRA, Sendai, Japan, (Nov. 4-6 1972); 12. JACOBS B E A, Design of Slurry Transport Systems, Taylor and Francis, London and New York, ISBN 1-85166-634-6, 105-150 (2006); 13. C. K. K. LUN, S. B. SAVAGE, D. J. JEFFREY, AND N. CHEPURNIY, Kinetic Theories for Granular Flow: Inelastic Particles in Couette Flow and Slightly Inelastic Particles in a General Flow Field, J. Fluid Mech., 140:223-256, (1984), 14. MANGESANA N, CHIKUKU R S, MAINZA A N, GOVENDER I VAN DER WESTHUIZEN A P AND NARASHIMA M., The effect of particle sizes and solids concentration on the rheology of silica sand based suspensions, Journal of the Southern African Institute of Mining and Metallurgy, 108, 237-243 (2008), 15. SAMARAS V C, MARGARIS D P, Two-phase flow regime maps for air-lift pump vertical gas-liquid flow, Int. J. of Multiphase Flows, 31, 757-766 (2005), 16. SHIMIZU Y, TOJO C SUZUKI M AND TAKAGAKI Y, Transport of solids according to air-lift principle, Proc. 2 International Offshore and Arctic Conf., San Francisco, USA, June 14-19, 490-497 (1992), 17. M. SYAMLAL, W. ROGERS, AND O'BRIEN T. J., MFIX Documentation: Volume 1, Theory Guide, National Technical Information Service, Springfield, Va., (1993), DOE/METC-9411004, NTIS/DE9400087, 18. THERON B. Ecoulements diphasiques instanuonarries en conduite horizontale, These de docteuringenieur, Institut National Polytechnique de Toulouse, France (in French) (1989), 19. WALLIS G B, One-dimensional two-phase flow, McGraw-Hill, New York (1969), 20. WEBER M AND DEDEGIL Y, Transport of solids according to air-lift principle, Proc. Hydrotransport 4 Conf., Paper H1, BHRA, Alberta, Canada, May 18-21 (1976).

### SUMMARY

In one embodiment of the present disclosure, a method of configuring an artificial lift system is provided. The method includes obtaining a reservoir data set comprising at least a pressure boundary condition of a subterranean formation and an in-situ solids concentration of a dense slurry near an inlet of a producer pipe of an artificial lift system; transforming the reservoir data into at least a second solids concentration of a diluted dense slurry and a diluted slurry flow rate of the diluted dense slurry utilizing a computational solid-liquid slurry model; and configuring at least one physical parameter of the artificial lift system using the second solids concentration and the diluted flow rate of the solid-liquid slurry.

In some embodiments, the method further includes building a gas fluid lift computational model configured to calculate: i) at least one gas fluid and diluted dense slurry physical velocity in the producer pipe based on the diluted slurry flow rate of the diluted dense slurry and a lift fluid flow rate; and ii) a slurry friction coefficient in the producer pipe based on a slurry rheology. The method may also include transforming the at least one gas fluid and diluted dense slurry physical velocity and the slurry friction coefficient into a pressure drop in the producer pipe using the gas fluid lift computational model; and configuring at least one additional physical parameter of the artificial lift system using the pressure drop in the producer pipe; and providing a process for producing a slurry utilizing the artificial lift system, comprising: (i) reducing a pressure at the producer pipe inlet to draw the dense slurry into the producer pipe, wherein the pressure is reduced using a jet pump directed towards the producer pipe inlet; (ii) generating the diluted dense slurry using the jet pump; (iii) flowing the diluted dense slurry into the producer pipe at the diluted slurry flow rate; and (iv) lifting the diluted dense slurry through the producer pipe utilizing a gasfluid lift apparatus. Still further embodiments may optionally include validating the fluid lift computational model using one of a volume of fluid (VOF) model and an Arbitrary Lagrangian Eulerian (ALE) model of fluid-slurry flow.

In a second embodiment of the present disclosure, a method of artificial lift modeling is provided. The method includes building a computational solid-liquid slurry model of a slurry production system in a subterranean formation having a dense slurry with an in-situ solids concentration and a pressure boundary condition near a producer pipe inlet, a producer pipe including the producer pipe inlet, a power fluid flow rate into the producer pipe through the producer pipe inlet configured to draw the dense slurry from the subsurface formation into the producer pipe at a slurry flow rate and mix the power fluid with the dense slurry to form a diluted dense slurry; and determining at least a predicted diluted solids concentration of the diluted dense slurry and a predicted flow rate of the diluted dense slurry for a given power fluid flow rate using the computational solid-liquid slurry model.

Some embodiments of the second embodiment may further include building a lift fluid computational model based on the computational solid-liquid slurry model of the slurry production system, the lift fluid computational model including at least a lift fluid flow rate configured to transport the diluted dense slurry up the producer pipe at a production flow rate, wherein the lift fluid has a lower density than the diluted dense slurry and the lift fluid is injected at a location spaced from the producer pipe inlet; and determining at least a predicted pressure drop in the producer pipe for a given lift fluid flow rate using the lift fluid computational model, the predicted diluted solids concentration of the diluted dense slurry, and the predicted flow rate of the diluted dense slurry from the computational solid-liquid slurry model, wherein the pressure boundary condition near the producer pipe inlet is a radial pressure gradient near the producer pipe inlet. The method may further include one of a volume of fluid (VOF) model of fluid-slurry flow and an Arbitrary Lagrangian Eulerian (ALE) model of fluid-slurry flow configured to validate the fluid lift computational model and the steps of exporting a result to a computing device, the result selected from the group consisting of: the predicted pressure drop in the producer pipe, the predicted diluted solids concentration of the diluted dense slurry, the predicted flow rate of the diluted dense slurry, and any combination thereof; and using the result to configure a parameter of an artificial lift system selected from the group consisting of: a depth of the producer pipe inlet, a power fluid flow rate, a configuration of the jet pump, a distance between an injection well and the producer pipe inlet, an inner diameter of the producer pipe, a lift fluid flow rate, a configuration of the lift fluid apparatus, and any combination thereof.

Still further embodiments of the second embodiment may include monitoring an active parameter to provide an active parameter real time value, the active parameter selected from the group consisting of: a measured pressure boundary condition; a measured pressure drop in the producer pipe; a measured flow rate of the diluted dense slurry; a measured power fluid flow rate; a measured lift fluid flow rate; and any combination thereof; and adjusting at least one parameter selected from the group consisting of: the power fluid flow rate; the lift fluid flow rate; and any combination thereof using at least one active parameter real time value, wherein the lift fluid computational model comprises: i) at least one gas fluid and diluted dense slurry physical velocity in the producer pipe based on the diluted slurry flow rate of the diluted dense slurry; and ii) a slurry friction coefficient in the producer pipe based on a slurry rheology.

In a third embodiment of the present disclosure, a method of controlling a slurry production process is provided. The method includes providing a method of producing a dense slurry from a subterranean formation, comprising: injecting a power fluid at a power fluid flow rate into a producer pipe through a producer pipe inlet to draw the dense slurry into the producer pipe at a slurry flow rate using a jet pump directed towards the producer pipe inlet; and obtaining a reservoir data set comprising at least a pressure boundary condition of the dense slurry in the subterranean formation and an in-situ solids concentration of the dense slurry in the subterranean formation; calculating at least the slurry flow rate from the injection fluid flow rate and the reservoir data set using a computational solid-liquid slurry model; and controlling the slurry flow rate by adjusting the injection fluid flow rate.

The third embodiment may further include generating a diluted dense slurry having a diluted dense slurry density as a result of mixing the power fluid and the dense slurry; and injecting a lift fluid into the producer pipe having a lower density than the diluted dense slurry at a location spaced from the producer pipe inlet at a lift fluid flow rate configured to transport the slurry up the producer pipe at a production fluid flow rate; and calculating the production fluid flow rate from the lift fluid flow rate and the diluted dense slurry density using a lift fluid computational model; and controlling the production fluid flow rate by adjusting the power fluid and lift fluid flow rates.

In a fourth embodiment of the present disclosure, a control system is provided. The control system includes a reservoir data set comprising at least a pressure boundary condition of a subterranean formation and an in-situ solids concentration of a dense slurry near an inlet of a producer pipe of an artificial lift system, the artificial lift system comprising: a) a well bore containing a producer pipe extending through an overburden below a surface of the earth into an oil sand reservoir, the producer pipe having an opening configured to permit the flow of a dense slurry into the producer pipe from the oil sand reservoir; b) a jet pump incorporated into the well bore configured to inject a power fluid at a power fluid injection rate sufficient to generate a low pressure region around the opening of the producer pipe to draw the dense slurry from the oil sand reservoir into the producer pipe and dilute the dense slurry to form a diluted dense slurry; and c) a slurry lift apparatus configured to lift the diluted dense slurry through the producer pipe towards the surface of the earth; a computational solid-liquid slurry model configured to transform the reservoir data into at least a second solids concentration of a diluted dense slurry and a diluted slurry flow rate of the diluted dense slurry; and a set of instructions on a computer-readable medium configured to control at least the power fluid injection rate.

### BRIEF DESCRIPTION OF THE DRAWINGS

The foregoing and other features and advantages of the present disclosure may become apparent upon reviewing the following detailed description and drawings of non-limiting examples of embodiments in which:

FIG. 1 illustrates an exemplary reservoir production system as contemplated by certain aspects of the present disclosure;

FIGS. 2A-2F illustrate various schematics of exemplary artificial lift systems that might be used in the reservoir production system of FIG. 1 and incorporating certain aspects of the present disclosure;

FIGS. 3A-3D illustrate flow diagrams for various methods of modeling, configuring, and controlling artificial lift processes such as in reservoir production systems like that shown in FIG. 1 in accordance with certain aspects of the present disclosure;

FIGS. 4A-4B illustrate two schematics of models incorporating certain aspects of the reservoir production system of FIG. 1, the artificial lift systems of FIGS. 2A-2F, and the processes of FIGS. 3A-3D;

FIG. 5 is a graphic of a chart showing production rates in a producer pipe as a function of jet pump power fluid flow rate using at least portions of the modeling method of FIG. 3C;

FIG. 6 is a graphic of a chart showing sand concentration in a producer pipe as a function of jet pump power fluid flow rate using at least portions of the modeling method of FIG. 3C and the slurry model of FIGS. 4A-4B;

FIG. 7 is a graphic illustration of an experimental result validation using portions of the modeling method of FIG. 3C and the lift fluid computational model of FIG. 4B;

FIG. 8 is a graphic illustration of an operating envelope using values from Table 1 and portions of the modeling method of FIG. 3C and the lift fluid computational model of FIG. 4B;

FIG. 9 is a graphic illustration of gas holdup profiles using values from Table 1 and portions of the modeling method of FIG. 3C and the lift fluid computational model of FIG. 4B;

FIG. 10 is a graphic illustration of physical slug velocities using values from Table 1 and portions of the modeling method of FIG. 3C and the lift fluid computational model of FIG. 4B;

FIG. 11 is a graph of a relationship between fluid and gas superficial velocities superimposed on a flow map for air lift applications;

FIG. 12 illustrates the volume of fluid (VOF) computational domain and results for an exemplary production case, as shown in FIGS. 1-4, to verify the results obtained in FIGS. 8-10; and

FIG. 13 is an illustration of a comparison of a predicted time averaged gas holdup by air lift using the numerical model of FIGS. 3-4 and results from the VOF model of FIG. 12.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

### DEFINITIONS

Various terms as used herein are defined below. To the extent a term used in a claim is not defined below, it should be given the broadest definition persons in the pertinent art have given that term as reflected in at least one printed publication or issued patent.

The terms “a” and “an,” as used herein, mean one or more when applied to any feature in embodiments of the present inventions described in the specification and claims.

The use of “a” and “an” does not limit the meaning to a single feature unless such a limit is specifically stated.

The term “about” is intended to allow some leeway in mathematical exactness to account for tolerances that are acceptable in the trade. Accordingly, any deviations upward or downward from the value modified by the term “about” in the range of 1% to 10% or less should be considered to be explicitly within the scope of the stated value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of and “consisting essentially of” shall be closed or semi-closed transitional phrases, respectively, as set forth in the United States Patent Office Manual of Patent Examining Procedures, Section 2111.03.

The term “dense slurry,” as used herein, refers to a slurry having a solids concentration range of about 30-65 volume percent (vol %). Such a dense slurry may be found naturally in-situ, may be generated by the FIRE process, or may be generated by another process.

The term “exemplary” is used exclusively herein to mean “serving as an example, instance, or illustration.” Any embodiment described herein as “exemplary” is not necessarily to be construed as preferred or advantageous over other embodiments.

The term “fluid lift apparatus,” as used herein, refers to any device configured to utilize a “lift fluid” to raise or elevate fluids, solids, or slurries to a surface location from a subterranean location. The lift fluid may be substantially homogenous or may be a combination or mixture of fluids. The lift fluid also has a lower density than the fluids, solids, or slurries being lifted. For example, the lift fluid may comprise a gas, such as air, carbon dioxide, nitrogen, argon, flue gas, and any combination thereof, but may also include small amounts of liquid residue and may include fluids that are in a liquid state at an early stage of the lift process, but transition to a gaseous or primarily gaseous state before or during the lift process.

The term “formation” refers to a body of rock or other subsurface solids that is sufficiently distinctive and continuous that it can be mapped. A “formation” can be a body of rock of predominantly one type or a combination of types. A formation can contain one or more hydrocarbon-bearing zones. Note that the terms “formation,” “reservoir,” and “interval” may be used interchangeably, but will generally be used to denote progressively smaller subsurface regions, zones or volumes. More specifically, a “formation” will generally be the largest subsurface region, a “reservoir” will generally be a region within the “formation” and will generally be a hydrocarbon-bearing zone (a formation, reservoir, or interval having oil, gas, heavy oil, and any combination thereof), and an “interval” will generally refer to a sub-region or portion of a “reservoir.”

The term “heavy oil” refers to any hydrocarbon or various mixtures of hydrocarbons that occur naturally, including bitumen and tar. In one or more embodiments, a heavy oil has a viscosity of between 1,000 centipoise (cP) and 10,000 cP. In one or more embodiments, a heavy oil has a viscosity of between 10,000 cP and 100,000 cP or between 100,000 cP and 1,000,000 cP or more than 1,000,000 cP at subsurface conditions of temperature and pressure.

The term “hydrocarbon-bearing zone,” as used herein, means a portion of a formation that contains hydrocarbons. One hydrocarbon zone can be separated from another hydrocarbon-bearing zone by zones of lower permeability such as mudstones, shales, or shaley (highly compacted) sands. In one or more embodiments, a hydrocarbon-bearing zone includes heavy oil in addition to sand, clay, or other porous solids.

The term “jet pump,” as used herein refers to any apparatus having a nozzle or nozzles configured to flow a fluid (e.g. a power fluid) through the nozzle such that: 1) the fluid is introduced into a producer pipe at a velocity higher than a natural velocity of the dense slurry flowing into the producer pipe without the jet pump; 2) the fluid flow creates a low pressure region in a subsurface formation adjacent to the jet pump that has a lower pressure than the formation's natural pressure; and 3) dilutes the dense slurry in the pipe to a density lower than the natural density of the formation.

The term “overburden” refers to the sediments or earth materials overlying the formation containing one or more hydrocarbon-bearing zones. The term “overburden stress” refers to the load per unit area or stress overlying an area or point of interest in the subsurface from the weight of the overlying sediments and fluids. In one or more embodiments, the “overburden stress” is the load per unit area or stress overlying the hydrocarbon-bearing zone that is being conditioned and/or produced according to the embodiments described.

The terms “preferred” and “preferably” refer to embodiments of the inventions that afford certain benefits under certain circumstances. However, other embodiments may also be preferred, under the same or other circumstances. Furthermore, the recitation of one or more preferred embodiments does not imply that other embodiments are not useful, and is not intended to exclude other embodiments from the scope of the inventions.

The terms “substantial” or “substantially,” as used herein, mean a relative amount of a material or characteristic that is sufficient to provide the intended effect. The exact degree of deviation allowable may in some cases depend on the specific context.

The definite article “the” preceding singular or plural nouns or noun phrases denotes a particular specified feature or particular specified features and may have a singular or plural connotation depending upon the context in which it is used.

### Description of Embodiments

The methods disclosed herein relate to design and control of slurry production systems. In particular, the slurry production system may be configured to produce an oil sand slurry from an oil sand formation that has an overburden and an underburden. Generally, such formations will be more than about 250 feet below the surface of the earth and up to at least about 2,000 or about 3,000 or about 4,000 feet or more under the surface of the earth. Such depths are generally considered to be too deep to efficiently extract oil sands by a surface mining extraction technique. The oil sands must be lifted from such depths for recovery and processing. As such, artificial lift (AL) systems, apparatuses, and methods have been developed to provide sufficient lift energy to the oil sand slurry. These new AL systems and methods are more fully described in co-pending, commonly assigned case number PM2008.122. Such AL systems may be coupled with other oil sand recovery techniques, such as SRBR, FIRE, “enhanced CHOPS,” and modifications of some heat and solvent related recovery and conditioning approaches that include producing a slurry from the reservoir to the surface.

In the commonly assigned, concurrently filed application titled “DENSE SLURRY PRODUCTION METHODS AND SYSTEMS,” (“Slurry Production case”) new methods and systems are disclosed for lifting a dense slurry from a subsurface formation. That disclosure is hereby incorporated by reference as if fully set forth herein. The new methods and systems of the Slurry Production case include a combination of a jet pump and a fluid lift apparatus in artificial lift (AL) systems and methods. What is still needed is a reliable computational model of such an AL system to design and configure such a system and evaluate system performance as a function of various design parameters. Such a predictive model must adequately account for a complex rheology of sand slurry as it determines pressure losses in the AL system. In particular, the model is capable of accounting for a transition from slow moving sand in the reservoir to fast moving sand in the producer well. Flow in the reservoir is controlled by interparticle friction (long term particle contact) while flow in the pipe is controlled by particle kinetics (particle free flight+momentary particle collision).

The disclosed methods include a computational solid-liquid slurry model. The model may be a Euler model in which two interpenetrating phases are considered (e.g. liquid and solid). Mass and momentum conservation equations are solved for each phase. In one form, the slurry model contains unknown terms accounting for interaction between phases and turbulence. In this case, the slurry model is complemented by a set of constitutive relations, which account for liquid-solid and solid-solid interaction. In particular, the liquid-solid interaction can be expressed by drag force based on Darcy's law, whereas the solid-solid interaction can be expressed by the sum of friction and kinetic stresses. In addition, there is a turbulence model accounting for additional momentum transfer due to turbulent fluctuations.

It should also be noted that a variety of friction, stress, and turbulence models can be used within the scope of the disclosed methods.

The solid-fluid model may be used to predict the flow rate of the solids into the producer well and a solids concentration of a diluted dense slurry given a pressure boundary condition and an in-situ solids concentration of a dense slurry.

The method may also include a second element comprising an analytical model of fluid lift of a solid-liquid slurry in the producer well. This model utilizes slurry flow rate and sand concentration predicted by the computational solid-liquid slurry model together with a lift fluid flow rate to calculate a pressure drop in the producer well. The fluid lift model is based on a momentum equation (pressure drop) and mass conservation equation for slurry and lift fluid. The fluid lift model is configured to use two relations: 1) calculating lift fluid holdup and lift fluid and slurry physical velocities given gas and slurry flow rates and 2) predicting a slurry friction coefficient based on a slurry rheology.

In addition, a third element may be used to validate the analytical fluid lift model. The third element may comprise a volume of fluid (VOF) model, an Arbitrary Lagrangian Eulerian (ALE) model, or other model of liquid-liquid flow capable to compute time dependent behavior of the flow of two immiscible fluids in the producer well.

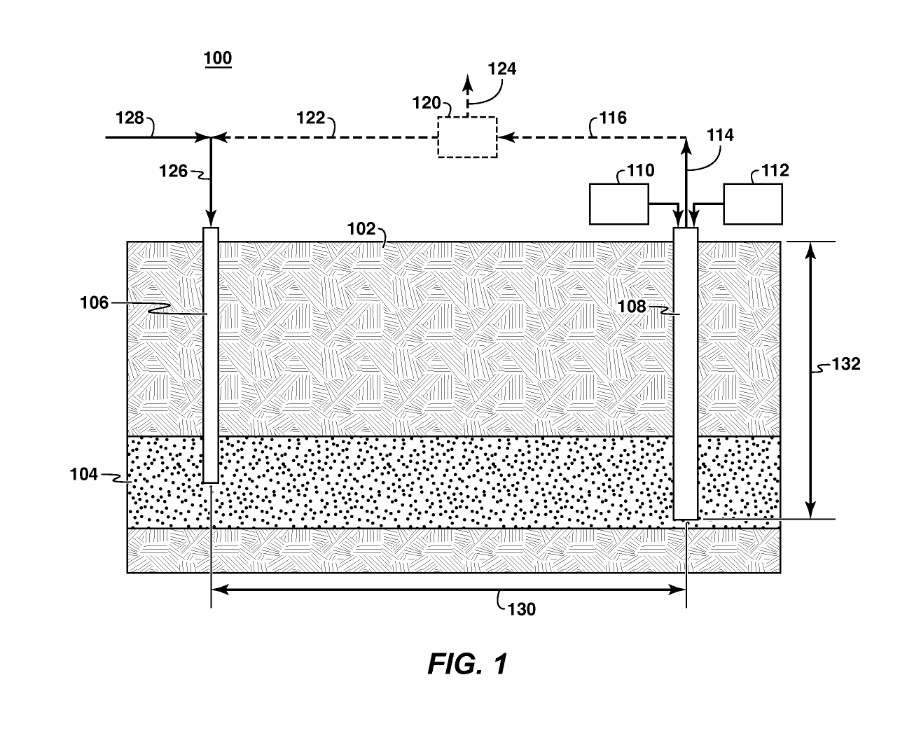

Referring now to the figures, FIG. 1 illustrates an exemplary reservoir production system as contemplated by certain aspects of the present disclosure. The reservoir system 100 includes an overburden 102, a producible oil sand formation 104, an injection well 106, and a production well 108. When an artificial lift system is included, the reservoir system 100 includes a fluid injection system 110, a power fluid injection system 112, and a slurry production stream 114. For injection, the reservoir system 100 further includes a fluid stream 126, an injection stream 128, a distance 130 between the injection well 106 and the production well 108, and a depth 132 of the production well 108. The reservoir system 100 may also optionally include a stream 116 to a separation system 120 configured to provide a re-injection stream 122, which may be combined with injection stream 128, and a post-separation production stream 124.

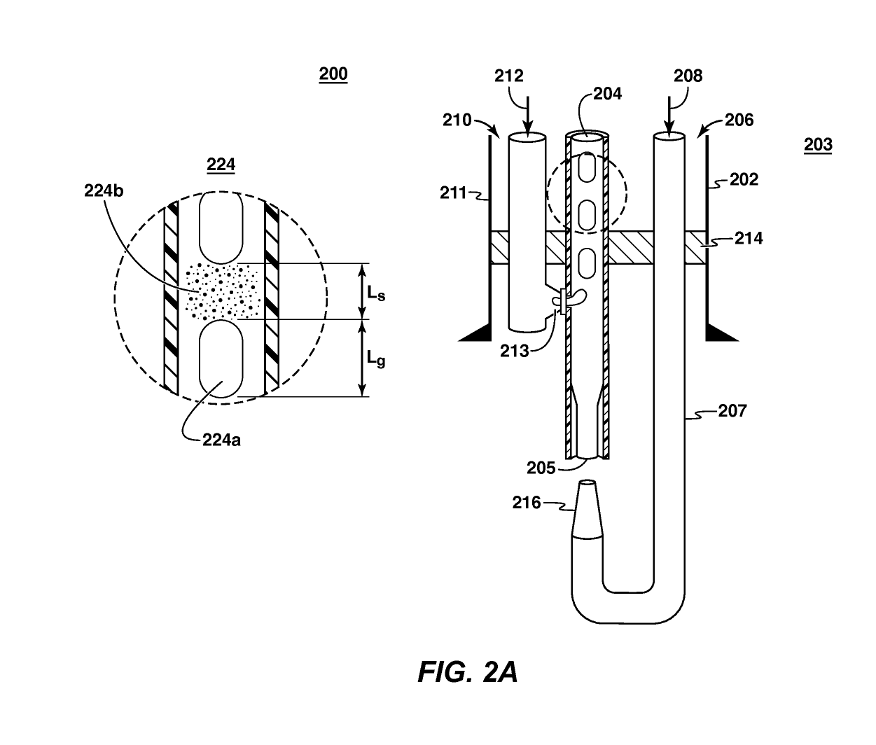

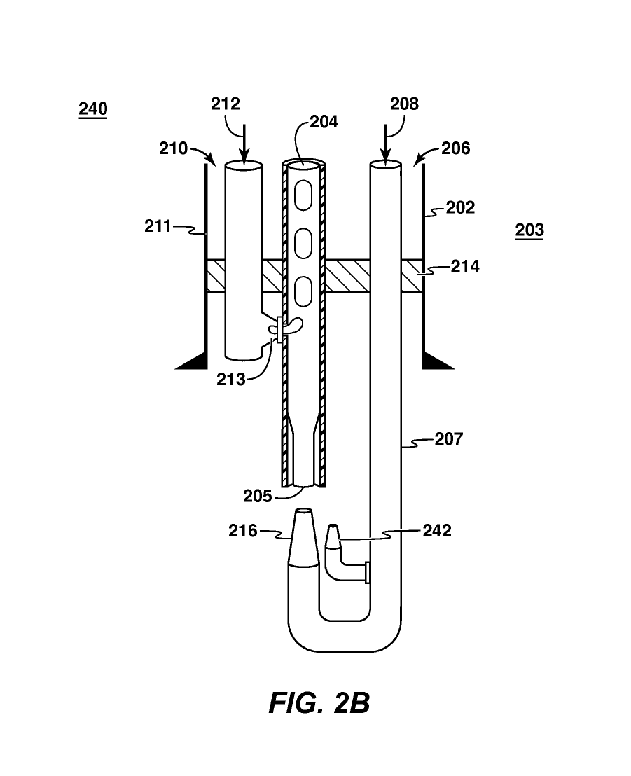

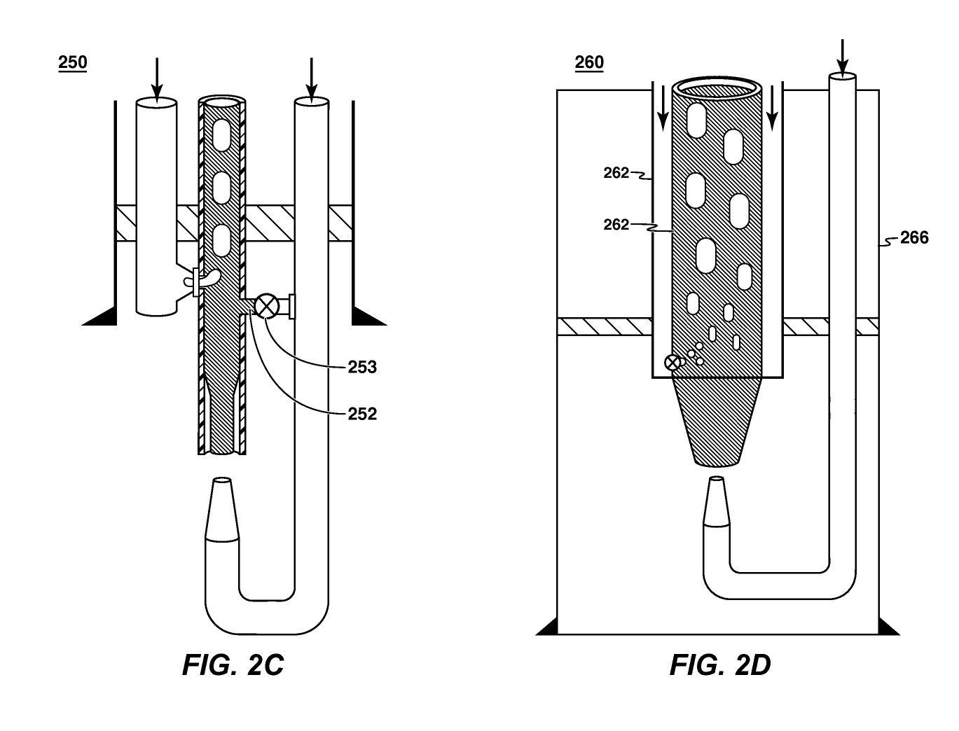

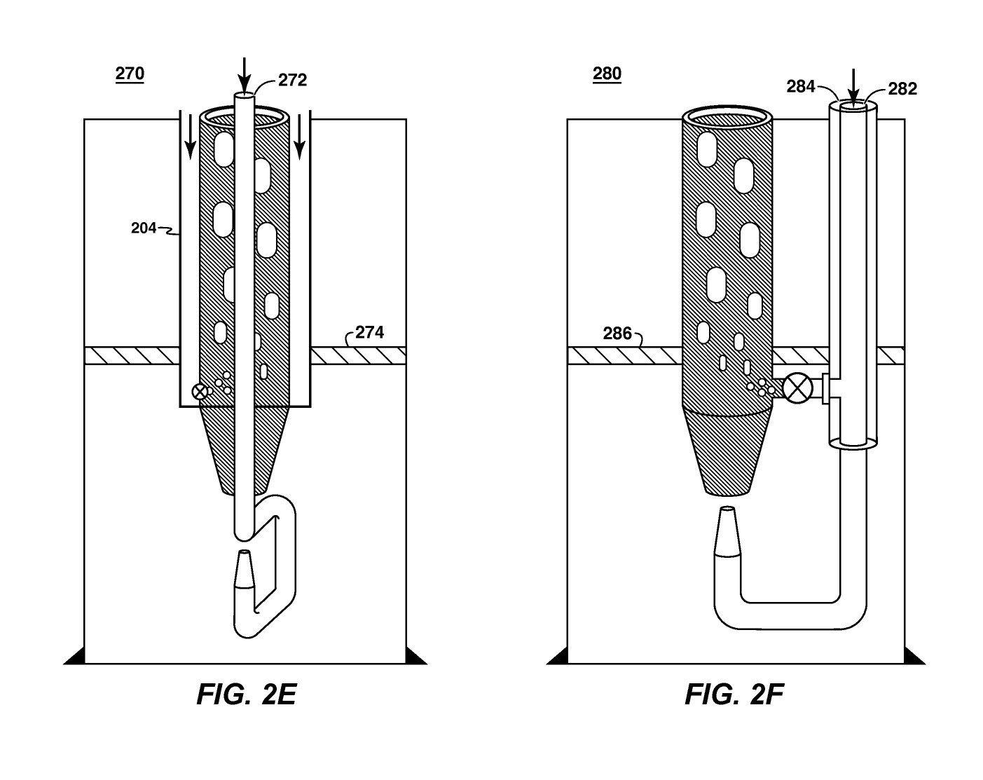

FIGS. 2A-2F illustrate various schematics of exemplary artificial lift systems that might be used in the reservoir production system of FIG. 1 and incorporating certain aspects of the disclosure. As such, FIGS. 2A-2F may be best understood with reference to FIG. 1. In particular, FIG. 2A shows a system 200 including a wellbore 202 in a subsurface formation 203 having a producer pipe 204 including a slurry input orifice 205, a jet pump apparatus 206 in the wellbore 202 comprising a power fluid conduit 207 configured to deliver power fluid 208 to a power fluid nozzle 216, and a fluid lift apparatus 210 in the wellbore 202 comprising a compressed fluid conduit 211 configured to deliver compressed fluid (gas) 212 into the producer pipe 204 through a side pocket valve 213. The conduits 204, 207, and 211 are held in the wellbore 202 with a triple production packer 214. In a detail view 224, a gas bubble 224a produced by the fluid lift apparatus 210 is shown as it lifts a slurry slug 224b generated and flowed by the jet pump 206. While FIGS. 2A-2F illustrate an exemplary jet pump apparatus 206, it should be understood that jet pump 206 is representative of the variety of inside-the-well dilution apparatus that may be used inject fluid inside the well.

It should be understood that the power fluid may be provided using a pump located at the surface, in the production well 108, or some other location. The pump power and speed may be controlled and monitored using equipment and techniques known in the art. Similarly, the compressed fluid may be provided to the fluid lift apparatus via a pump or other pressurized fluid system located on the surface, in the production well 108, some combination, or some other location.

Note that the side valve 213 should be appropriately designed to handle increased erosion from slurry stirred by the gas next to the valve entrance to the producer pipe 204. The system 200 may even include redundant or alternative valves 213 (not shown) in the event of failure to avoid a costly work-over. Injected gas is expected to form a bubble and rise up the pipe 204 forming large elongated bubbles 224a intermingled with slurry slugs 224b. Such flow is called “slug flow.”

In general, as bubbles 224a move up, their volume will increase (hence, their length, L_{g}, will also increase) due to the expected pressure decrease. The larger bubbles 224a will accelerate and push slurry slugs 224b faster. Turbulence is expected to increase in such accelerated slurry slugs 224b. Beneficially, this is expected to lead to improved conditioning of the slurry due to increased shear of particles. One side effect of such acceleration will be an increase in friction losses. As such, appropriately large producer pipe 204 diameter should be chosen to keep frictional pressure loss minimal. On the other hand, increased producer pipe 204 diameter will warrant a large gas flow rate so an optimum producer pipe 204 diameter should be determined. In one exemplary embodiment, it is expected that a producer pipe 204 diameter of from about 0.1 to about 0.6 meters or about 0.1 to about 0.4 m is desirable. However, in some embodiments, it is beneficial to make a more precise determination of the optimum diameter based on the conditions of the subsurface formation, depth, expected diluted dense slurry flow rate, composition of the diluted dense slurry, and other factors.

FIG. 2B depicts a system 240 having an array of secondary spray nozzles 242 configured to provide additional dilution to the diluted dense slurry in the artificial lift system. The nozzles 242 may also increase the amount of conditioning of the diluted dense slurry by increasing the turbulent flow of the power fluid through the producer pipe inlet 205. These nozzles 242 are optional and may be controlled to be in an on or off position, and may further have a controllable flow rate, depending on modeling and configuration results.

FIG. 2C depicts a system 250 having an additional slurry dilution conduit 252 configured to permit flow of power fluid from the power fluid conduit 207 to the producer pipe 204. The system 250 is a possible lift design for a shallow reservoir, such as a reservoir at a depth of from about 400 feet to about 1,000 feet or less. Such a shallow reservoir may have a relatively small Bottom Hole Pressure (BHP), which could result in a more dense slurry flowing into the producer pipe 204. In such a situation, fluid lift may not be feasible, warranting further slurry dilution inside the producer pipe 204, which may be via the dilution conduit 252 and valve 253. Note that the opening of the dilution conduit 252 may be adjustable via valve 253 and may have an optimal or near optimal size based on results obtained from the configuration method described below. It should also be noted that the dilution conduit 252 may be used in combination with the additional nozzles 242, but will typically be an alternative solution.

FIG. 2D illustrates a system 260 where the compressed fluid conduit 262 is positioned concentrically around the production pipe 264 with the compressed fluid being supplied through an annulus formed between the compressed fluid conduit 262 and the production pipe 264. Note that the packer 266 is a double packer rather than a triple packer 214, as shown in the systems 200, 240, and 250. Such an arrangement 260 may be easier to install.

FIG. 2E illustrates a system 270 having a power fluid conduit 272 located concentrically through the production pipe 204 and a single production packer 274. FIG. 2F illustrates a system 280 having a power fluid conduit 282 and a compressed fluid conduit 284 in a concentric configuration with respect to each other, but offset from the production pipe 204 and having a double production packer 286.

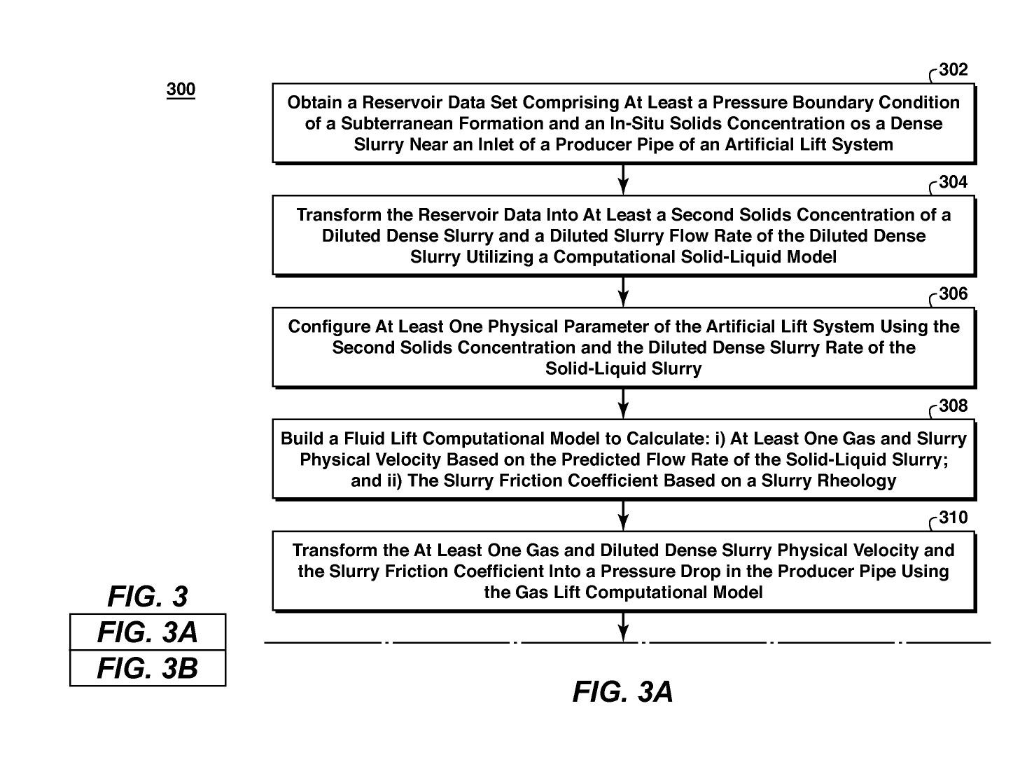

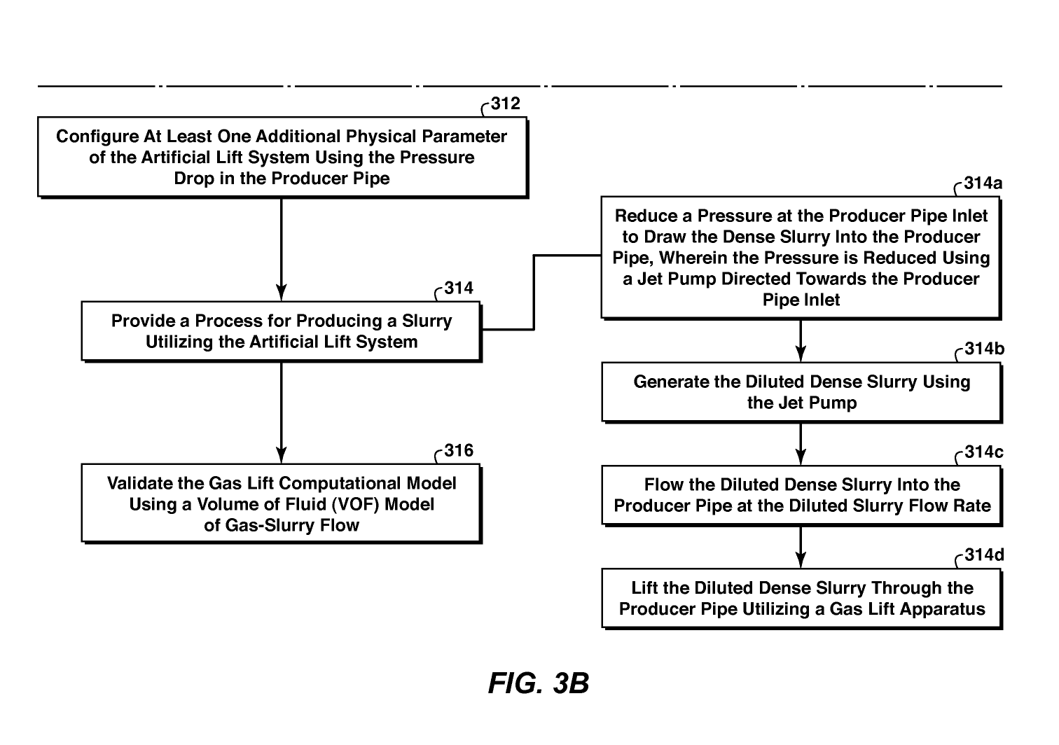

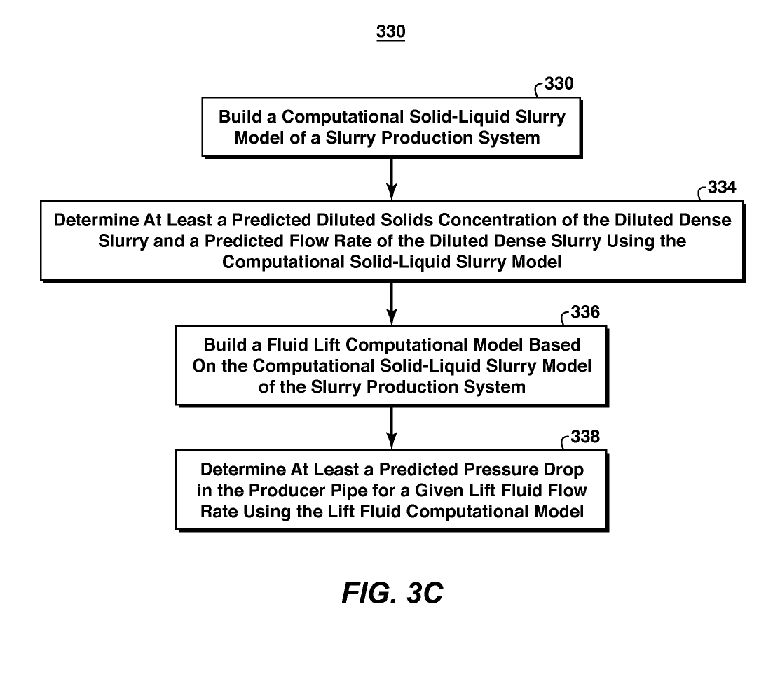

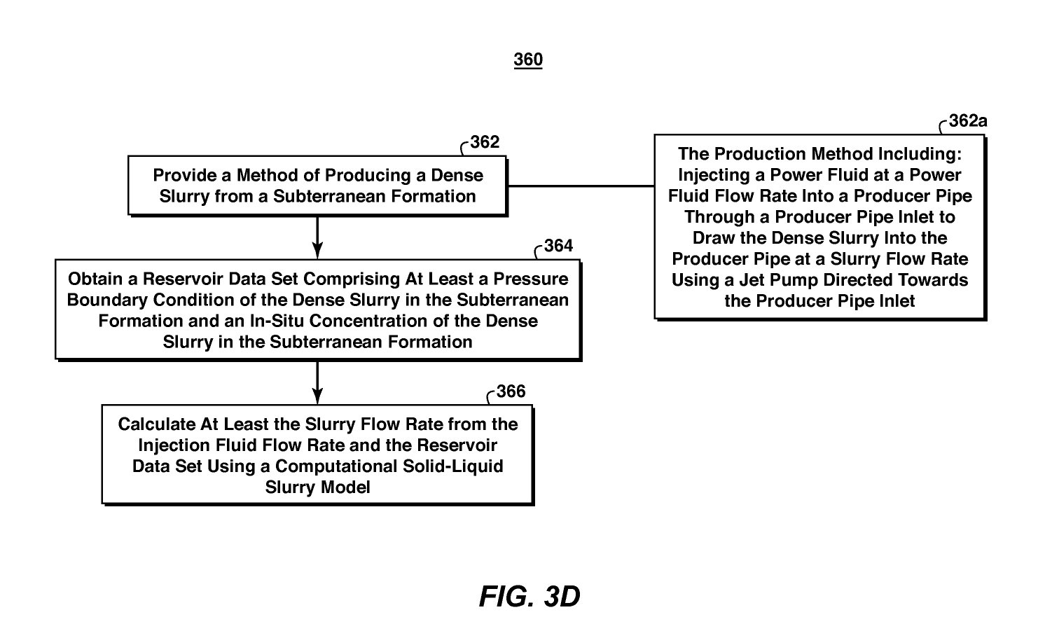

FIGS. 3A-3D illustrate flow diagrams for various methods of modeling, configuring, and controlling artificial lift processes, such as in reservoir production systems like that shown in FIG. 1, in accordance with certain aspects of the disclosure. Note, that some embodiments of the illustrated methods may incorporate portions of the artificial lift systems shown in FIGS. 2A-2F. As such, FIGS. 3A-3D may be best understood with reference to FIGS. 1 and 2A-2F. In particular, FIGS. 3A-3B show a flow chart of an exemplary method 300 of configuring an artificial lift system. The method 300 begins with the step 302 of obtaining a reservoir data set comprising at least a pressure boundary condition of a subterranean formation and an in-situ solids concentration of a dense slurry near an inlet of a producer pipe of an artificial lift system. A transforming step 304, then includes transforming the reservoir data into at least a second solids concentration of a diluted dense slurry and a diluted slurry flow rate of the diluted dense slurry utilizing a computational solid-liquid slurry model; and a configuring step 306 includes configuring at least one physical parameter of the artificial lift system using the second solids concentration and the diluted flow rate of the solid-liquid slurry. The process 300 may also include a step 308 of building a fluid lift computational model. The fluid lift computational model is configured to calculate: i) at least one fluid and diluted dense slurry physical velocity in the producer pipe based on the diluted slurry flow rate of the diluted dense slurry and lift fluid flow rate; and ii) a slurry friction coefficient in the producer pipe based on a slurry rheology.

Additional aspects of the method may include step 310 of transforming the at least one fluid and diluted dense slurry physical velocity and the slurry friction coefficient into a pressure drop in the producer pipe using the fluid lift computational model; and the step 312 of configuring at least one additional physical parameter of the artificial lift system using the pressure drop in the producer pipe. Further, a process for producing a slurry using the artificial lift system may be provided in step 314. The process may include the steps of 314a reducing a pressure at the producer pipe inlet to draw the dense slurry into the producer pipe, wherein the pressure is reduced using a jet pump directed towards the producer pipe inlet; the step 314b of generating the diluted dense slurry using the jet pump; the step 314c of flowing the diluted dense slurry into the producer pipe at the diluted slurry flow rate; and the step 314d of lifting the diluted dense slurry through the producer pipe utilizing a fluid lift apparatus.

FIG. 3C illustrates a flow diagram of an artificial lift modeling method 330. The method 330 includes the step 332 of building a computational solid-liquid slurry model of a slurry production system in a subterranean formation having a dense slurry with an in-situ solids concentration and a pressure boundary condition near a producer pipe inlet, a producer pipe including the producer pipe inlet, a power fluid flow rate into the producer pipe through the producer pipe inlet configured to draw the dense slurry from the subsurface formation into the producer pipe at a slurry flow rate and mix the power fluid with the dense slurry to form a diluted dense slurry. The method 330 further includes the step 334 of determining at least a predicted diluted solids concentration of the diluted dense slurry and a predicted flow rate of the diluted dense slurry for a given power fluid flow rate using the computational solid-liquid slurry model.

FIG. 3D illustrates a flow diagram of a method 360 of controlling a slurry production process. The method 360 includes the step 362 of providing a method of producing a dense slurry from a subterranean formation. The slurry production method includes the sub-step 362a of injecting a power fluid at a power fluid flow rate into a producer pipe through a producer pipe inlet to draw the dense slurry into the producer pipe at a slurry flow rate using a jet pump directed towards the producer pipe inlet. The method 360 further includes the step 364 of obtaining a reservoir data set comprising at least an pressure condition of the dense slurry in the subterranean formation and an in-situ solids concentration of the dense slurry in the subterranean formation, the step 366 of calculating at least the slurry flow rate from the injection fluid flow rate and the reservoir data set using a computational solid-liquid slurry model, and the step 368 of controlling the slurry flow rate by adjusting the injection fluid flow rate.

Example methods, such as those shown in FIGS. 3A-3D, may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

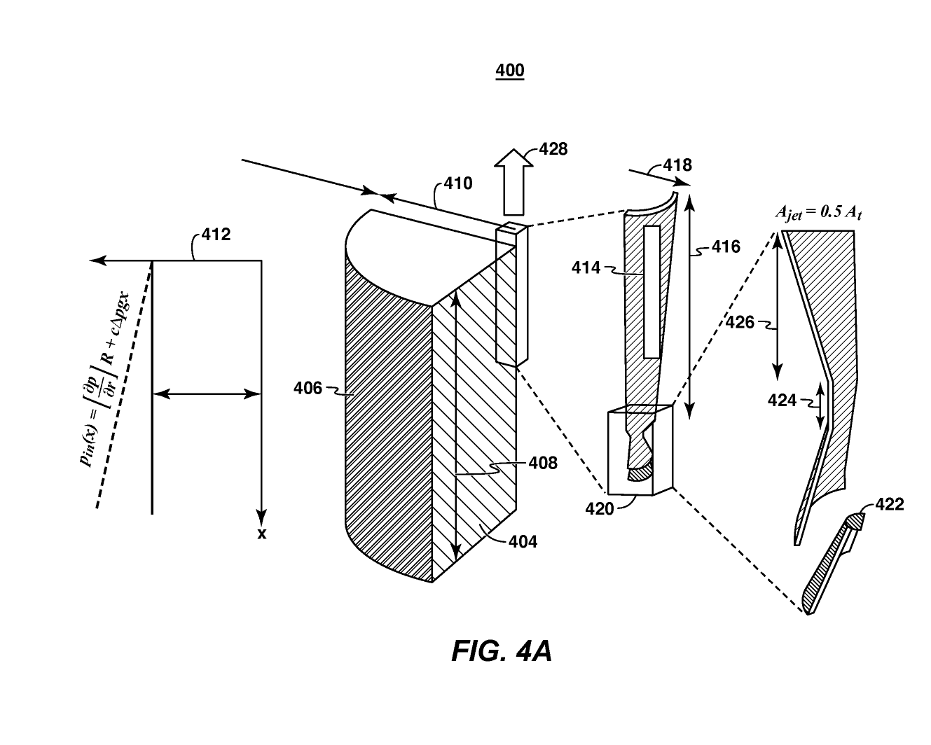

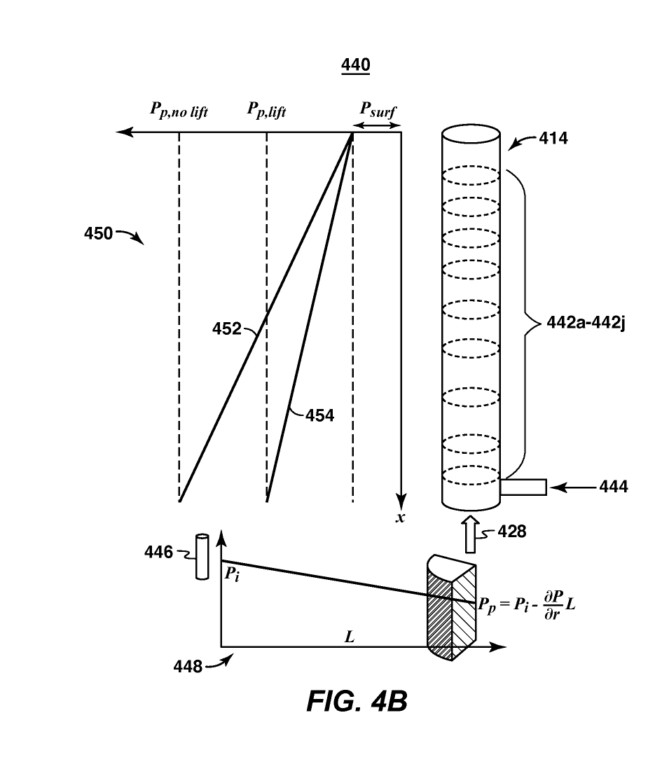

FIGS. 4A-4B illustrate two schematics of models incorporating certain aspects of the reservoir production system of FIG. 1, the artificial lift systems of FIGS. 2A-2F, and the processes of FIGS. 3A-3D. As such, FIGS. 4A-4B may be best understood with reference to FIGS. 1, 2A-2F, and 3A-3D. FIG. 4A includes a schematic 400 showing basic computational elements of the computational solid-liquid slurry model. The schematic 400 includes an overburden 402, an underburden 404, a slurry inlet 406, a total height (H) 408, a total radius (R) 410, and a pore pressure 412 as a function of x. The schematic 400 further includes a producer pipe 414 with a height (h) 416 and a radius (r) 418 and a jet pump 420, wherein the jet pump 420 includes a jet 422, a throat 424 with a throat flow area (Aₜ) and a diffuser 426. As shown, the schematic 400 uses the computational solid-liquid slurry model to produce predicted values 428 including at least the predicted flow rate of the diluted dense slurry (J_{solids}, J_{liquids}) and the predicted diluted solids concentration of the diluted dense slurry (C_{S}).

In one embodiment of the schematic 400, the coordinate domain is cylindrical and a quarter of the system is modeled and symmetry is used to extrapolate. The producer pipe 414 is located on the axis of the domain together with the jet pump 420 at its entrance. The jet pump 420 consists of jet cone 422, throat 424 and diffuser 426. A power fluid from the jet cone 422 mixes with the slurry at the throat 424 to form the diluted slurry with the second solids concentration. The throat flow area Aₜ must be larger than the jet area Aⱼₑₜ to avoid stall. In one exemplary embodiment of the model the throat area is twice the jet area (Aⱼₑₜ=0.5·Aₜ). The jet cone 422 may have any working geometry in the model, it can have larger relative size and other shapes. Additional injection of fluid in the vicinity of the jet pump entrance can be modeled too. The aim of such injection might be additional dilution of slurry before it enters the throat 424.

FIG. 4B includes a schematic 440 showing basic computational elements of the fluid lift computational model. The schematic 440 includes the producer pipe 414 divided into control volumes 442a-442j, a fluid lift entry point 444, a reservoir diagram with an injector 446 and a pressure gradient 448 over a distance (L) between the injector 446 and the slurry inlet 406 and bottom hole pressure (BHP) 450 as a function of x with exemplary pressure gradients for a case with no fluid lift 452 and a case with fluid lift 454. The model is configured to receive the predicted values 428 to produce model results.

In this exemplary system, the schematic 440 is a one dimensional domain. Ten or twenty control volumes may be used to obtain a grid independent solution. The predicted values 428 are used in conjunction with a fluid flow rate provided through the fluid lift entry point 444. This fluid flow rate is searched by an iterative trial and error method depending on the type of lift process utilized. For example, the criteria for the fluid flow rate may include a flowing condition for a process such as the FIRE™ process. The flowing condition means a smooth pressure reduction from the injector well 446 pressure pᵢ to Bottom Hole Pressure (pₚ) 450 of the producer well to a known surface pressure p_{surf}. As such, on one side of the equation, the bottom hole pressure (BHP) should be equal to the injector well pressure pᵢ minus the pressure due to horizontal sand flow resistance expressed by the horizontal pressure gradient ∂p/∂r for a well spacing L as shown by equation (1):

$${p}_{p} = {p}_{i} - {\int }_{0}^{L} \frac{\partial p}{\partial r} d r \qquad ( 1 )$$

On the other side of the equation, the Bottom Hole Pressure should be equal to the known surface pressure p_{surf} augmented by a vertical pressure head in the production pipe 442 expressed by the vertical pressure gradient ∂p/∂x (static and frictional) for a well depth h as shown by equation (2):

$${p}_{p} = {p}_{surf} + {\int }_{0}^{h} \frac{\partial p}{\partial x} d x \qquad ( 2 )$$

Combining equation (1) and equation (2), the mathematical form of the flowing condition is shown by equation (3):

$${p}_{i} - {\int }_{0}^{L} \frac{\partial p}{\partial r} d r = {p}_{surf} + {\int }_{0}^{h} \frac{\partial p}{\partial x} d x \qquad ( 3 )$$

If the right hand side of equation (3) above is larger than the left hand side, then the Bottom Hole Pressure is not enough to lift the slurry up the producer pipe 242, and no flow will occur. One approach to ensure flow is to reduce the vertical pressure gradient ∂p/∂x by, for example, providing fluid lift.

Referring back to FIG. 2A, in one exemplary embodiment of the disclosed methods, both the gas bubbles 224a and the slurry slugs 224b may be assumed to move up the tubing 204 at approximately the same physical speed Vₜ. In such a case, the bubble rise speed Vₜ may be calculated using the friction between the slurry slugs 224b and the tubing 204. In this exemplary model, the presence of small gas bubbles in slurry slugs and the influence of slurry film between wall and gas bubble may be neglected as insubstantial at high slurry speeds. The pressure gradient in such a flow is mainly due to two components: static pressure head and friction loss. Both of these components are assumed to be significant only in the slurry slugs 224b. Given these assumptions, the total local vertical pressure gradient (dp/dx) may be represented as:

$$\frac{d p}{d x} = \frac{d p}{d {x}_{static}} + \frac{\partial p}{\partial {x}_{friction}} = [ \frac{Δ ρ g}{{ρ}_{sl}} + \frac{2 {f}_{sl} {V}_{t}^{2}}{D} ] {α}_{sl} {ρ}_{sl} \qquad ( 4 )$$

In equation (4) above, αₛₗ is a local slurry volume fraction. There are two unknown parameters in equation (4)—the physical slug velocity (Vₜ) and the friction coefficient (fₛₗ). One way to relate Vₜ to gas and slurry superficial velocity (J_{g}) may be represented by the following equation:

Vₜ=C₀(J_{g}+Jₛ)+V_{d} (5)

For air-water flows, C₀=1.2, V_{d}=0.35\sqrt{gD}. The constant, C₀ is approximately equal to the ratio of maximum to mean velocity of fluid in front of a gas bubble, i.e., by friction of the fluid slug. For turbulent flows of Newtonian fluids, this ratio is indeed 1.2 and for laminar flows it is 2, i.e., C₀≅2. In non-Newtonian slurries like tar sand, the velocity profile differs from the Newtonian flow regime, so a different value of C₀ is expected. No established theory exists to predict the value of C₀ for a given slurry. In general, slurries are characterized by higher viscosity so it is expected that in turbulent slurry slug flows, C₀>1.2, i.e., bubbles are rising faster than in Newtonian fluids. The physical meaning of V_{d} is rising velocity of bubble in stagnant fluid. Often, gas bubbles cannot rise in concentrated slurries due to very high viscosity so it is expected that V_{d}≅0 in concentrated slurries like tar sand. Measurements of Heywood and Charles (1980) in 16.6% kaoline slurry confirm our assumptions: C₀=1.6, V_{d}≅0.

In an alternative exemplary embodiment of the disclosed methods, the total local vertical pressure gradient (dp/dx) may be assumed to include additional gravitational and frictional components attributed to slurry film between bubble and pipe wall. In some cases, the friction contribution can even be negative when this film flows downward. With film influence in mind, the static pressure component of the local vertical pressure gradient (dp/dx) becomes:

$$\frac{d p}{d {x}_{static}} = Δ ρ g ( {α}_{sl} - {α}_{film} ( 1 - \frac{{L}_{s}}{{L}_{s} + {L}_{g}} ) ) \qquad ( 6 )$$

Where neglecting entrained air bubbles in the slurry one can connect:

$$\frac{{L}_{s}}{{L}_{s} + {L}_{g}} ≅ \frac{{α}_{sl} - {α}_{film}}{1 - {α}_{film}} \qquad ( 7 )$$

The average film holdup α_{film} may be related to average film thickness δ as:

α_{film}≅4δ/D (8)

If the film flow is significant, then bubble V_{b} and film V_{f} physical velocities will be different:

$${V}_{t} ≅ {V}_{b} ≅ \frac{( {J}_{g} + {J}_{s} ) + {V}_{f} 4 δ / D}{1 - 4 δ / D} \qquad ( 9 )$$

In addition, the average film thickness (δ) can be calculated separately based on the film Reynolds number and the slurry rheology. Other methods of computing velocities and frictional coefficients are possible. One may simply change the assumptions based on the conditions that are being modeled, configured, monitored, or solved for. Such alterations would be understood by those of ordinary skill in the art.

The Wallis equation, which is valid for slug and churn flow regimes, allows finding the slurry volume fraction:

$${α}_{sl} = 1 - {α}_{g} = 1 - \frac{{J}_{g}}{{V}_{t}} \qquad ( 10 )$$

In addition, a slurry friction coefficient fₛₗ should be calculated. Water-sand slurry at high concentrations exhibit non-Newtonian dilatant behavior. One exemplary method of finding the friction coefficient for turbulent and laminar pipe non-Newtonian fluid flow may be used to estimate fₛₗ. In particular, it is known that dense sand slurry has non-Newtonian behavior described by Herschel-Bulkley model:

τ=τ_{Y}+K\dot{γ}ⁿ (11)

The rheology of a clean sand-water mixture for a sand concentration range of about 40 to about 50%, a dilatant behavior is observed, which may result in the following relation: τ_{Y}=0.1-4 Pa, n=1.55>1. In such a case, the slurry friction coefficient is a function of a generalized Re number:

$$Re = {\frac{{D}^{n} {V}_{t}^{2 - n} {ρ}_{s}}{{8}^{n - 1} K} [ \frac{4 n}{3 n + 1} ]}^{n} \\ f = 16 / Re , Re < ( 2000 - 6000 ) - laminar \\ f = a / {Re}^{b} , Re > 2000 - 6000 - turbulent \\ a = 0.0781 {c}^{0.1099} \\ b = 0.2503 {c}^{- 0.2188} \qquad ( 12 )$$

In one embodiment, the computational solid-liquid slurry model is configured to use a summation of models of two types of stresses acting on sand around and inside the jet pump. The first type of stress is the friction stress dominant in reservoir around the pump for a first solids concentration range (e.g. based on Darcy's law) and the second type of stress is the non-ideal gas (NIG) stress dominant inside the pump at a second solids concentration range, which is lower (more diluted) than the first solids concentration range. The sum of these two types of stresses may be used to calculate jet pump performance and a slurry concentration. The results may then be used in the fluid lift computational model.

In one particular embodiment of the disclosure, the computational solid-liquid slurry model is an Euler model of multiphase flow. In particular, for each phase (e.g. solid and fluid) at steady state, a continuity equation may be solved for the sand concentration c:

∇·[(1−c)·\vec{U}_{f}]=0 (fluids)

∇·[c·\vec{U}ₛ]=0 (solids) (13)

The computational solid-liquid slurry model also includes fluids and solids momentum equations having a pore pressure gradient term ∇p_{f}, drag due to Darcy's law between fluids and solids with permeability k(c), gravity cΔρ\vec{g}, and granular stress ∇Tᵢⱼ (including NIG and friction stress):

$$∇ ( {ρ}_{f} ( 1 - c ) {\vec{U}}_{f} {\vec{U}}_{f} ) = - ( 1 - c ) ∇ {p}_{f} - \frac{{μ}_{f} ( 1 - c ) ( {\vec{U}}_{f} - {\vec{U}}_{s} )}{k ( c )} \\ ( fluids ) \\ ∇ ( {ρ}_{s} c {\vec{U}}_{s} {\vec{U}}_{s} ) = - c ∇ {p}_{f} \frac{{μ}_{f} ( 1 - c ) ( {\vec{U}}_{f} - {\vec{U}}_{s} )}{k ( c )} - ∇ \cdot {T}_{ij} + c Δ ρ \vec{g} \\ ( solids ) \qquad ( 14 )$$

The momentum equations (14) are then solved for fluid (\vec{U}_{f}) and solid (\vec{U}ₛ) velocity.

Interparticle force density ∇Tᵢⱼ may be approximated based on known conditions, may be calculated as the sum of the non-ideal gas (or kinetic) stress and frictional stress components, or may incorporate other components.

Tᵢⱼ=^{k}Tᵢⱼ+^{f}Tᵢⱼ (15)

The frictional model of equation (15) is configured to predict the increase in sand friction from the static regime to the kinetic regime (NIG) when sand is rapidly sheared.

In one embodiment of the disclosed methods, the fluid lift computational model may account for the influence of sand concentration predicted by the computational solid-liquid slurry model on a non-Newtonian rheology of the slurry. Such an approach should beneficially provide a connection between the slurry concentration and the slurry friction. Such a connection beneficially allows a prediction of a gas bubble velocity and a slug translational velocity, which leads to a gas holdup prediction and a frictional pressure drop. Thus, a total pressure loss determined by slurry friction and gas content may be calculated.

The basis of this model is a simplified momentum equation of slurry and air mixture. At the nominal slurry production rate of about 300-3000 m³/day in inner diameter (ID) 20 cm producer well, the mixture velocity in the well is 0.1-1 m/sec which far exceeds falling velocity of sand in water. This means that slurry can be treated as a homogeneous mixture of sand and water with sand concentration c and mixture density ρₛₗ=ρₛc+(1−c)ρ_{f}. Mass conservation of air and slurry in the pipe with cross section area A requires that mass flow rate of slurry and air is preserved in any pipe cross section. Note that the second solids concentration and a second flow rate of the solid-liquid slurry (Jₛₗ) at the injection location may be provided by the computational solid-liquid slurry model.

Given the shallow depths of producer well, the slurry is assumed to be incompressible. Gas is compressible, so given the inlet mass flow rate of the gas \dot{m}_{g,in} the gas superficial velocity at a given local pressure p_{f} is:

$${J}_{g} = \frac{{m}_{g , i n}}{A {ρ}_{g} ( {p}_{f} , T )} \qquad ( 16 )$$

For the pressure range in the producer well assuming isothermal flow:

$${ρ}_{g} = {ρ}_{g} ( {p}_{f , i n} ) \frac{{p}_{f}}{{p}_{f , i n}} \qquad ( 17 )$$

Note that the gas superficial velocity (J_{g}) is inversely proportional to the local gas pressure (p_{f}).

### EXAMPLES

The processes, models, and systems described above can be used for a variety of purposes, including designing a slurry lift system. In one aspect, the numerical model can predict producer well performance for various physical parameters such as depth of the producer pipe inlet h, a flow rate of the jet pump, horizontal pressure gradient (∂p/∂r), in situ slurry concentration cᵢₙ, a configuration of the jet pump, a distance between an injection well and the producer pipe inlet, an inner diameter of the producer pipe, a flow rate of the fluid lift apparatus, a configuration of the fluid lift apparatus, and combinations of these and other physical parameters.

For this example, it is helpful to refer to FIGS. 4A-4B. In particular, the horizontal pressure gradient (∂p/∂d) was set by specifying a pressure of zero at the outlet of the producer pipe 414 and setting the vertical inlet pressure profile 412 as:

$${p}_{i n} ( x ) ≅ R \frac{\partial p}{\partial r} + {c}_{i n} Δ ρ gx \qquad ( 18 )$$

In this example, the incoming slurry concentration cᵢₙ is determined by setting an appropriate value for cᵢₙ at the slurry inlet. For a typical loose tar sand, cᵢₙ≅0.58 and any vertical variation of the sand concentration is neglected. In a calculation such as this one, the following parameters may be used:

$$R = 5 m$$

$$H = 10 m$$

$$r = 0.1 m$$

$$h = 2 m$$

$${c}_{i n} = 0.5751$$

$$and$$

$$\frac{\partial p}{\partial r} = 10 kPa \text{/} m$$

For this example, the friction pressure was calculated based on the assumption that the sand concentration in a reservoir never falls below the particle contact concentration i.e., below about 48%. Therefore, the adopted expression for friction pressure ^{f}P assumes that friction pressure disappears when local sand concentration falls below some minimum level (47.45% in this example).

$${}^{f} P = \{ \begin{matrix}c Δ ρ x , c > 0.4745 \\ 0 , c \leq 0.4745\end{matrix} \qquad ( 19 )$$

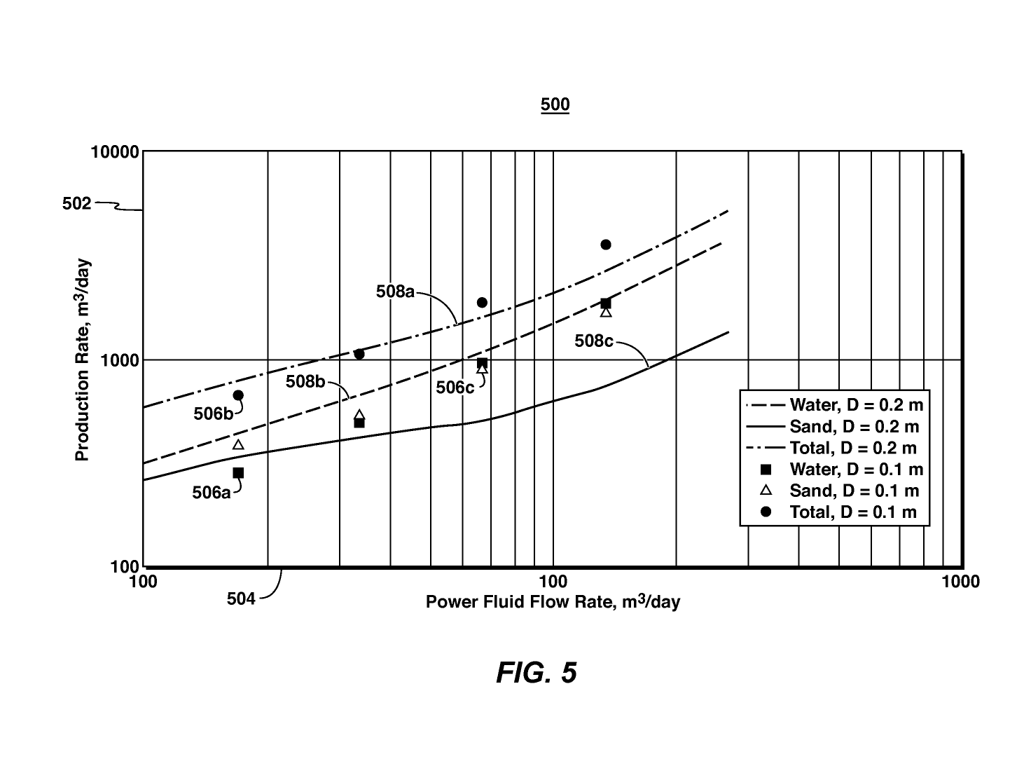

FIG. 5 is a graphic of a chart showing production rates in a producer pipe as a function of jet pump power fluid flow rate using at least portions of the modeling method of FIG. 3C. As such, FIG. 5 may be best understood with reference to FIG. 3C. The graph 500 shows production rate 502 in cubic meters per day (m³/d) versus jet pump power fluid rate 504 in m³/d in a log scale. One set of results is shown for a producer pipe having a 0.05 meter (m) radius (0.1 m inner diameter—ID) for sand 506c, water 506b, and combined water and sand (total) 506a. A second set of results is shown for a producer pipe having a 0.1 m radius for sand 508c, water 508b, and combined water and sand (total) 508a.

For each pump flow rate, sand and water flow rates together with sand concentration at the outlet were calculated using the model 330. As the jet pump power fluid flow rate increases, so does the slurry production rate. At higher power fluid flow rates, when the slurry production rate becomes about 1000 m³/day, the flow resistance is mainly due to turbulence and particle collisions. In this regime, resistance coefficient near the production pipe weakly depends on Reynolds number so there is insignificant difference between production rates of ID 0.2 and 0.1 m pipes. In particular, the model predicts that 1,000 m³/d slurry production is achieved at a power fluid rate of about 300 m³/d for both pipe diameters. More specifically, for the 0.1 m ID pipe, the power fluid rate was calculated to be about 337 m³/d and for the 0.2 m ID pipe, this rate was about 303 m³/d.

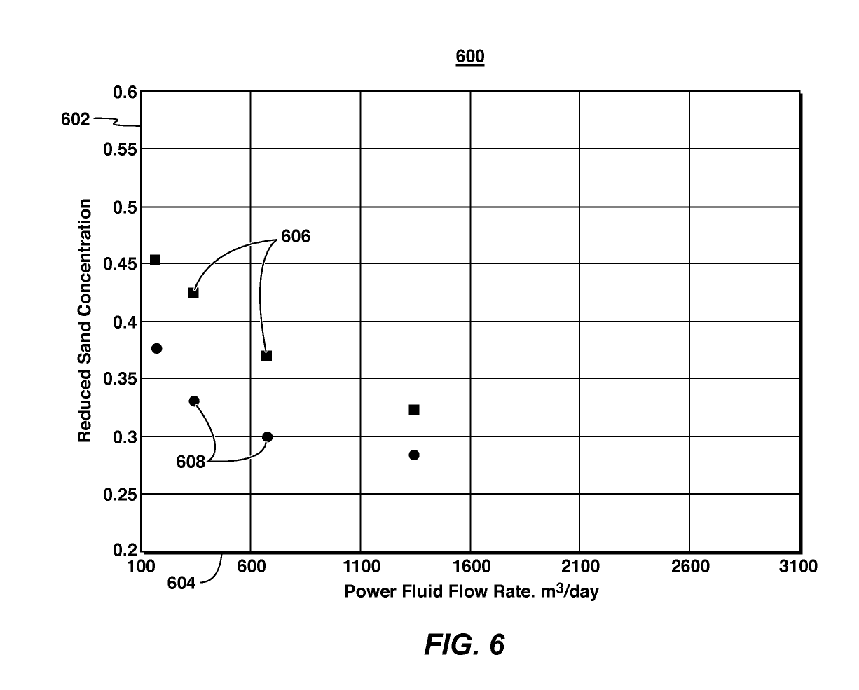

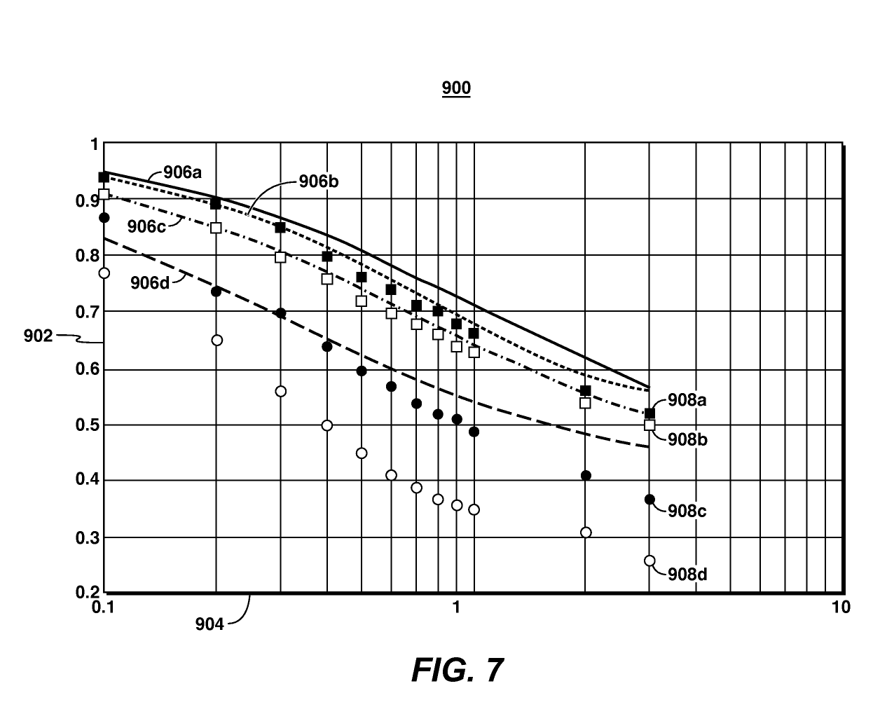

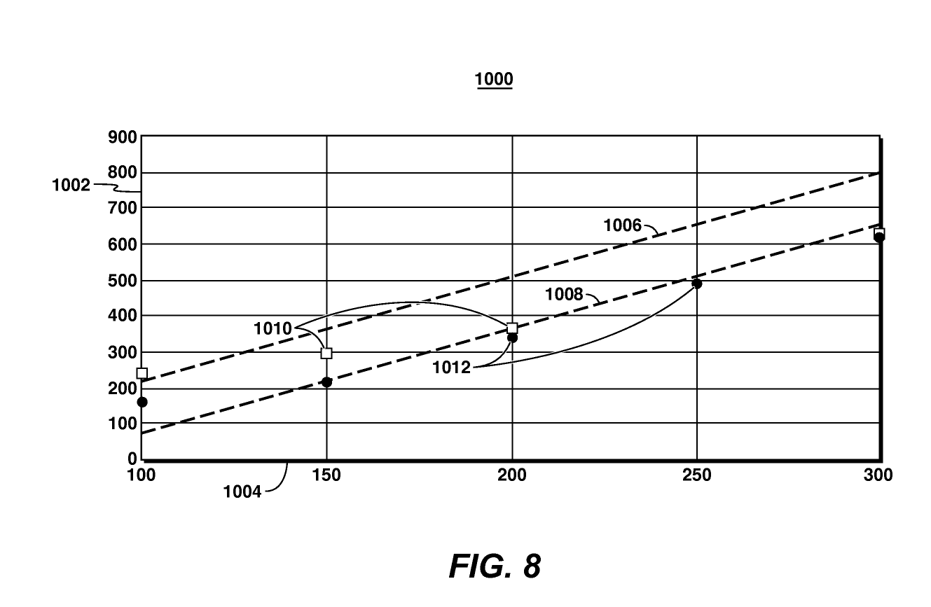

FIG. 6 is a graphic of a chart showing sand concentration in a producer pipe as a function of jet pump power fluid flow rate using at least portions of the modeling method of FIG. 3C and the slurry model of FIGS. 4A-4B. As such, FIG. 6 may be best understood with reference to FIGS. 3B and 4A-4B. The chart 600 shows sand concentration (as a volume fraction) 602 versus jet pump power fluid flow rate in cubic meters per day (m³/d) 604. Data points 606 show the results for a producer pipe 414 with a 0.1 m radius (ID of 0.2 m) and data points 608 show results for r=0.05 (ID of 0.1 m). As expected, an increase in power fluid flow rate leads to a reduction of sand concentration. At higher power fluid flow rates, the sand concentration seems to approach a constant value of about 0.30 (30%). Also, the sand concentration 608 (ID of 0.2 m) is slightly higher than for sand concentration 606 (0.1 m pipe).

The next step of the example is fluid lift computation. From FIG. 5, a power fluid flow rate of 337 m³/day was found to produce about 1,000 m³/day of slurry for both 0.1 and 0.2 m pipes. The predicted inlet sand concentrations (C₀) are 37% and 30% for 0.2 and 0.1 m pipes, respectively. The surface pressure is chosen be 50 psia (345 kPa). There is also inter-well spacing of L=200 m. Practically, depending on the depth of the sand layer, a certain fluid pressure is needed to support an overburden with a density of 2,000 kg/m³. This overburden support condition dictates a choice of injector pressure and, given the horizontal pressure gradient 448 (∂p/∂r) (also referred to as “frictional pressure loss”) of 10-20 kPa/m, determines a bottom hole pressure 450 for the producer well 414. For example, given a well spacing, L of 200 m and a frictional pressure loss 448 of 10 kPa/m, the initial pressure at the injector well 446 must be greater than 2,000 kPa to result in a positive BHP 450 at the producer well inlet 406. Another consideration is wall erosion—its magnitude strongly depends on slug physical velocity (Vₜ) and preferably does not exceed about 1 meter per second (m/s), but slug physical velocities up to about 5 m/s near the top of a well may be acceptable. Gas holdup may be calculated by a variety of methods. For the present example, the Wallis formula was used:

$${α}_{g} = \frac{{J}_{g}}{{C}_{o} ( {J}_{g} + {J}_{sl} )} \qquad ( 20 )$$

The equation above states that increasing the gas flow rate significantly above the slurry flow rate does not lead to a proportional gas holdup increase and a corresponding static head reduction. Put another way, a higher gas flow rate leads to a higher gas rise velocity and the result is a slower rate of gas holdup increase. Another possible detriment is that the increase in gas flow rate leads to an increase of bubble and slug physical speed (Vₜ) leading to increased friction losses. Friction is more significant for pipes of smaller diameter. Therefore, for a given well depth and slurry flow rate, there is a minimum possible pressure gradient reduction that can be achieved with gas lift operating in the slug regime (friction neglected). This minimum pressure is directly connected to the constant C₀ (C₀ is the ratio of maximum to mean velocity of fluids in front of a gas bubble) by the following relationship:

$$\frac{d p}{d {x}_{m i n}} = {ρ}_{sl} g ( 1 - \frac{1}{{C}_{0}} ) \qquad ( 21 )$$

As shown by equation 21, the minimum achievable pressure drop (dp/dxₘᵢₙ) depends on sand concentration (c) in the slurry because slurry density (ρₛₗ) and the constant, C₀ are functions of sand concentration (c). Hence, increases in sand concentration lead to increases of both slurry density (ρₛₗ) and the constant, C₀, so gas lift may inherently be less efficient for more concentrated slurries if the value of C₀ grows with increasing slurry concentration.

Table 1 below gives estimates of fluid lift performance for various depths of a petroleum reservoir. As shown, the real fluid lift pressure gradient (dp/dx) will be higher than the minimum (dp/dxₘᵢₙ) due to the finite rate of fluid injection restricted by the maximum 1 m/sec gas velocity due to the erosion constraint. The friction contribution is small for all reservoir depths and does not exceed about 4% of the total pressure drop. In calculations, the following values of constant C₀ were assumed: C₀=2 (maximum possible) for sand concentration c=37% and C₀=1.7 for sand concentration c=20%. Sand concentration of 20% was included to evaluate the merit of possible additional slurry dilution in the producer well 414 by extra water injection inside the well. In some implementations, the further dilution may be accomplished using a single jet pump apparatus. Additionally or alternatively, a jet pump apparatus and an additional in-well fluid injection system, which may be identical to or different from the jet pump apparatus, may be implemented to accomplish the further dilution.

TABLE 1

| | | Slurry | | | |
|---|---|---|---|---|---|
| | | concentration | | | |
| | | after initial | | | |
| | | dilution | | | |
| | | (37%) | | | Gas |
| | Range | and after | | Pipe | flow rate |
| | of | additional | BHP_{lift}, | dia- | at BHP, |
| Depth, | BHP | dilution | (BHPₘᵢₙ), in | meter, | pₛ and pₐₜₘ, |
| in m | in MPa | (20%) | MPa | in m | in Mscfd |
| 100 | 0.5-1.5 | 20 | 1.16 (0.87) | 0.4¹ | 35², 117, |
| | | | | | 404 |
| | | 37 | 1.61 (1.17) | 0.4 | 35, 145, 502 |
| 150 | 1.5-2.5 | 20 | 1.55 (1.14) | 0.4 | 35, 155, 539 |
| | | 37 | 1.97 (1.58) | 0.4 | 35, 197, 686 |
| 200 | 2.5-3.5 | 20 | 2.4 (1.4) | 0.3 | 8.8³, 60, 209 |
| | | 37 | 2.5 (1.99) | 0.4 | 35, 248, 868 |
| 250 | 3.5-4.5 | 20 | 3.42 (1.66) | 0.2 | 1.4, 14, 477 |
| | | 37 | (2.4) | 0.3 | 8.8, 89, 312 |
| 300 | 4.5-5.5 | 20 | 4.3 (1.93) | 0.2 | No gas lift |
| | | 37 | 4.3 (2.81) | 0.3 | needed |
| | | | | | 7.1, 85, 301 |

Notes:
¹Recommended diameter such that slug velocity is below 1 m/s, i.e., minimal erosion.
²About 35 thousand standard cubic feet per day (Mscfd) of gas at BHP means the gas volume flow rate is equal to the nominal slurry flow rate of about 1,000 m³/day.
³Producer pipe diameter is recommended based on minimum friction loss and erosion.

In order for an oil sand reservoir extraction process (e.g. the FIRE™ process) to be effective, the bottom hole pressure (BHP) should be in a certain range to ensure that sand can flow from the injector 446 to the producer 414. This range depends on depth and well spacing and flow rate in the reservoir. The gas flow rate was chosen to fit 3 criteria simultaneously: i) it should not exceed the volume flow rate of slurry at the bottom of the producer well, ii) slug velocity is kept below 1 m/sec, and iii) lift BHP is below the lower limit of the overburden BHP whenever possible. As shown in Table 1, for a 100 m deep reservoir and a 37% slurry concentration, fluid lift is practically impossible. In this case, the slurry must be further diluted to 20% or less for fluid lift to become possible. For a 150 m deep reservoir, further dilution to 20% is desired to improve fluid lift performance for the whole range of BHPs. Starting from 200 m and deeper reservoirs, fluid lift is possible for both 20 and 37% sand concentrations (c) so no additional dilution is needed. However, the lower limit on the producer pipe diameter is 0.2 m for 20% versus 0.3 m for 37% slurry to allow for flow rates below the erosion limit.

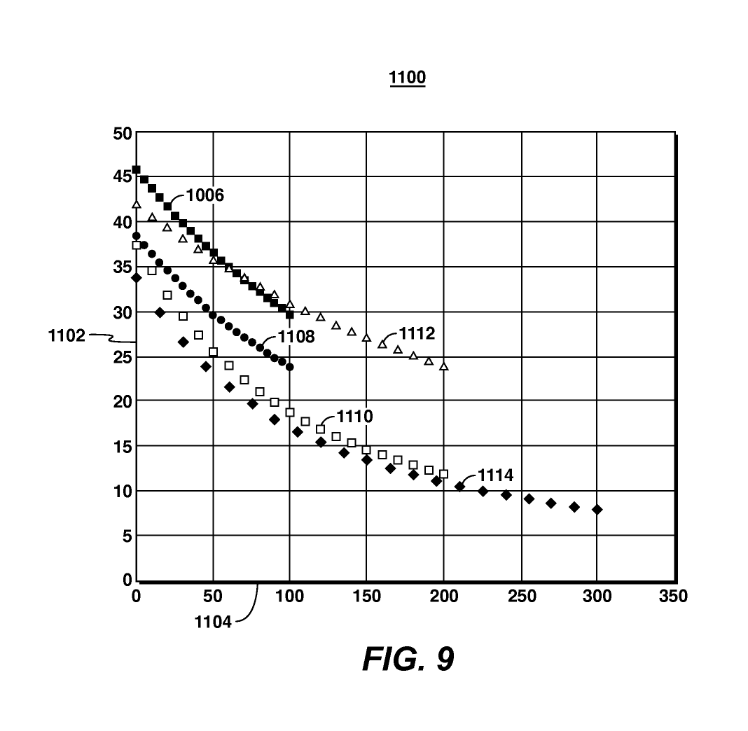

FIG. 9 is a graphic illustration of an experimental result validation using portions of the modeling method of FIG. 3C and the lift fluid computational model of FIG. 4B. As such, FIG. 9 may be best understood with reference to FIGS. 3C and 4B. The graph 900 relates total pressure drop ratio 902 along the vertical axis with gas mean superficial velocity in meters per second (m/s) 904 in a log scale. The solid lines 906a-906d represent the results of the numerical model 330, while the data points 908a-908d represent data from the kaoline slurry experiments of Heywood and Charles (1980) discussed above. Line 906a corresponds to data points 908a, and the remaining lines and data points correspond according to their letter designations. The pressure drop ratio 902 is the ratio between the pressure drop with gas injection over the pressure drop without gas injection. The line 906a and data points 908a are for 0 volume percent (vol %) sand concentration (cᵥ) and a slurry superficial velocity (Jₛ) of 1.02 m/s. Line 906b and data points 908b are for 16.6 vol % cᵥ and 1.02 m/s Jₛ; line 906c and data points 908c are for 16.6 vol % cᵥ and 0.68 m/s Jₛ; and line 906d and data points 908d are for 16.6 vol % cᵥ and 0.36 m/s Jₛ.

As shown, the numerical model results 906a-906b agree very closely with the experimental results 908a-908b for the higher slurry superficial velocity (Jₛ) of 1.02 m/s at 0 vol % and 16.6 vol % sand concentrations. As the slurry superficial velocity decreases, as in 906c-906d and 908c-908d, the agreement between the numerical model and the data is a reasonable approximation, but not as good as for the higher slurry superficial velocities. One likely explanation is that the particular version of the model 330 did not take into account the influence of slurry film between wall and gas bubble, which is minimal at higher velocities (e.g. 1.02 m/s), but more substantial at lower velocities. In any case, the results of FIG. 9 are encouraging, and tend to show that the disclosed model provides useful results.

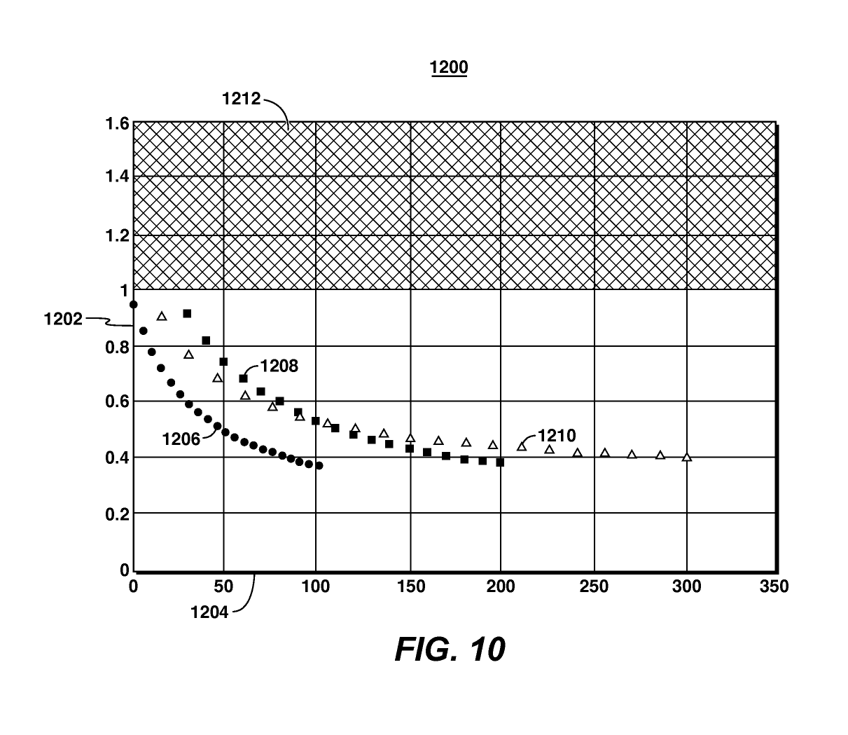

FIG. 10 is a graphic illustration of an operating envelope using values from Table 1 and portions of the modeling method of FIG. 3C and the lift fluid computational model of FIG. 4B. As such, FIG. 10 may be best understood with reference to FIGS. 3C and 4B. The graph 1000 compares bottom hole pressure (BHP) 1002 in psi and well depth (total vertical depth—TVD) 1004 in meters (m), and shows two diagonal lines representing the upper limit 1006 and the lower limit 1008 for a FIRE production operation. This range for FIRE flow is fixed by pore pressure necessary to support the overburden. Also shown are squares 1010 representing the BHP achieved for 37% solid concentration slurry (w/o erosion) and triangles 1012 for 20% solid concentration slurry. As shown, gas lift is not feasible for 37% slurry coming from a shallow well (100 m depth) because gas cannot provide a sufficient pressure gradient reduction at the economical production rate.

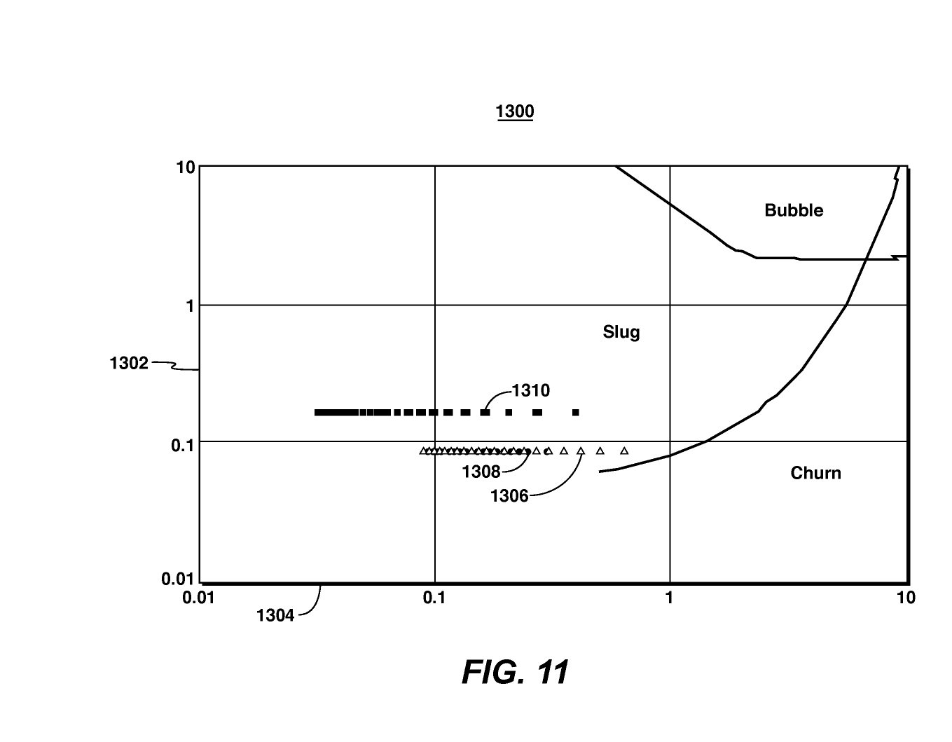

FIG. 11 is a graphic illustration of gas holdup profiles using values from Table 1 and portions of the modeling method of FIG. 3C and the lift fluid computational model of FIG. 4B. As such, FIG. 11 may be best understood with reference to FIGS. 3C and 4B. The graph 1100 compares gas holdup (e.g. gas concentration) 1102 in volume percent (vol %) with total vertical depth (TVD) 1104. Points 1106 plot this relationship to a depth of 100 m and sand concentration of 20 vol %; points 1108 are for 100 m and 37 vol %; points 1110 are for 200 m and 20 vol %; points 1112 are for 200 m and 37 vol %; and 1114 are for 300 m and 37 vol %. It is interesting to note that for all recommended gas flow rates and slurry concentrations (1106, 1108, 1110, 1112, and 1114), the gas holdup never reaches its maximum value of 50 vol %, as gas holdup over 50 vol % can result in numerous undesirable consequences, including high erosion rates.

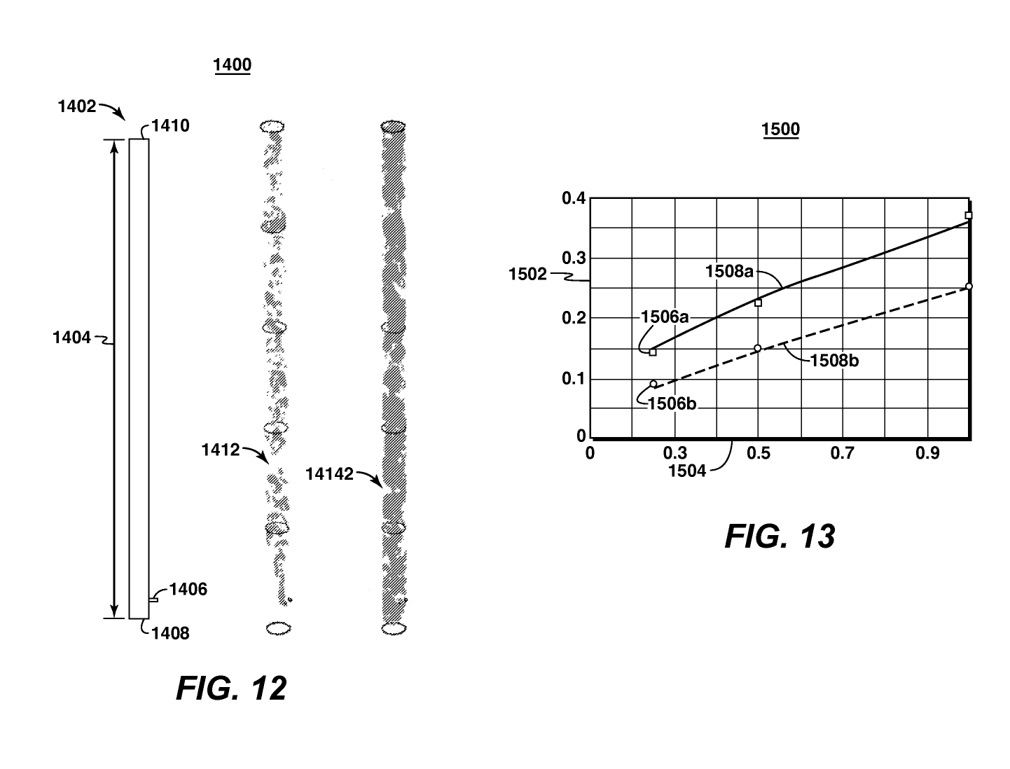

FIG. 12 is a graphic illustration of physical slug velocities using values from Table 1 and portions of the modeling method of FIG. 3C and the lift fluid computational model of FIG. 4B. As such, FIG. 12 may be best understood with reference to FIGS. 3C and 4B. The graph 1200 compares physical slug velocity (Vₜ) 1202 with total vertical depth 1204 for three cases. Points 1206 plot this relationship to a depth of 100 m and a production pipe 414 inner diameter (ID) of 0.4 m; points 1208 are for 200 m and 0.4 m ID; points 1210 are for 300 m and 0.2 m ID. The shaded area 1212 is the “erosion velocity range,” which corresponds to a physical slug velocity 1202 of greater than 1 m/s and is considered to damage tubulars at this rate. Note that even the worst erosion case shown by plot 1208 does not pass through the 1 m/s barrier until about the last 25 m of pipe. This is generally acceptable as it is not prohibitively expensive to replace or “work over” such a small portion of the pipe. Another approach could be to install thick or erosion-resistant pipe near the top of the well to avoid replacement in the area where some erosion is expected.

FIG. 13 is a graph of a relationship between fluid and gas superficial velocities superimposed on a flow map for air lift applications. The graph 1300 includes fluid superficial velocity (J_{f}) 1302 in m/s and gas superficial velocity (J_{g}) 1304 in m/s, both in a log scale. Points 1306 plot this relationship at a depth of 100 m and a sand concentration (c) of 20 vol %, points 1308 are for 200 m and c=37 vol %; and points 1310 are for 300 m and c=37 vol %. This check was made to verify the expected flow regime. As shown, the flow regime is either slug or on the slug-churn transition. Although the flow map is an approximation, the results indicate that the slug flow regime is an appropriate assumption for the types of systems considered in Table 1.

Predictions from the fluid lift computational model were further compared to a Volume of Fluid (VOF) model implemented in Fluent 6.3 computational fluid dynamics (CFD) code. The VOF model is able to predict the evolution of the gas-liquid interface. Thus, an appropriately time averaged solution of the VOF model can be directly compared to the fluid lift model.

To verify results using the VOF approach, the FIRE production case having a 0.2 m ID production well and 1,000 m³/day slurry production rate at 37% slurry concentration was selected. FIG. 14 illustrates the volume of fluid (VOF) computational domain and results for an exemplary production case, as shown in FIGS. 1-4, to verify the results obtained in FIGS. 10-12. As such, FIG. 14 may be best understood with reference to FIGS. 10-12. The illustration 1400 includes a computational volume 1402 having a computational domain height 1404 of 5 m, which was chosen because it is short enough to neglect gas compressibility effects and long enough to obtain a fully developed gas-slurry flow. In this example, gas was injected through a 2 cm ID side pipe 1406 (e.g. 213 in system 200) imitating a conventional gas lift valve inlet, a slurry inlet 1408, (e.g. slurry inlet 406) and a slurry-gas outlet 1410. Gas inlet velocity was appropriately chosen for the same gas flow rate at 200 m and 100 m depth to keep the same mass flow rate. The slurry rheology described above and corresponding to 37 vol % sand concentration was implemented.

Reservoir depths of 200 m and 100 m were simulated by setting an appropriate gas density. Three gas flow rates corresponding to 0.25, 0.5 and 1 times the nominal slurry flow rate of 1,000 m³/day were chosen at a depth of 200 m to systematically investigate the gas flow regime and the gas holdup (concentration) evolution.

Illustration 1412 shows the results of the VOF model for a gas-slurry interface for the lowest gas content corresponding to a 0.25 rate ratio and 200 m depth. Illustration 1414 shows the results of the VOF model for a gas-slurry interface for the highest gas content corresponding to a 1.0 rate ratio and 100 m depth. As shown, the lowest gas content 1412 manifests in appearance of isolated large gas bubbles and small bubbles in slurry slugs. The largest gas content 1414 manifests itself in the appearance of large gas bubbles intermingled with slurry slugs. The VOF model predicts a chum flow regime rather than a slug flow regime, although the flow map 1300 shows flow in the slug regime. This is acceptable. Again, the velocity of large bubbles (Taylor or irregular bubble) occupying a majority of the pipe cross section is determined by the friction of the fluid slug in front of the bubble. As long as this assumption holds, all of the equations above should be reasonably valid.

FIG. 15 is an illustration of a comparison of a predicted time averaged gas holdup by air lift using the numerical model of FIGS. 3-4 and results from the VOF model of FIG. 14. As such, FIG. 15 may be best understood with reference to FIGS. 3-4 and 14. As shown, the graph 1500 compares gas holdup 1502 in decimal fraction with gas to slurry flow rate ratio 1504 in decimal fraction. Points 1506a-1506b show the results of the VOF model and lines 1508a-1508b show the results for the numerical model 330. Excellent agreement is observed between the two sets of results, thus confirming the validity of the Wallis formula (equation 20 above) for the chum flow. This comparison 1500 also predicted a negligible contribution of friction because the pressure gradient is primarily due to the hydrostatic component.

As shown, the calculations from the numerical model 330 agree reasonably well with experimental data and other observable indications, especially for lower gas superficial velocity (e.g. J_{g} less than about 1 m/s) and higher slurry superficial velocity (e.g. Jₛₗ greater than about 1 m/s). The exemplary calculations also confirm that the model predictions tend to be conservative, i.e., underestimate the pressure gradient reduction caused by gas lift. Thus, estimates by the disclosed model under the exemplary assumptions and conditions are expected to give predictions with some safety margin.

Advancements in related art may change accepted design parameters and may lead to different conclusions. For example, use of more advanced materials or pipe linings may lead to a change of the admissible erosion velocity (e.g. about 1 m/s) and, consequently, to smaller pipe diameters.

While the present disclosure may be susceptible to various modifications and alternative forms, the exemplary embodiments discussed above have been shown only by way of example. However, it should again be understood that the disclosure is not intended to be limited to the particular embodiments disclosed herein. Indeed, the present disclosure includes all alternatives, modifications, and equivalents falling within the true spirit and scope of the appended claims.

What is claimed is:

1. A method of configuring an artificial lift system, comprising:
obtaining a reservoir data set comprising at least a pressure boundary condition of a subterranean formation and an in-situ solids concentration of a dense slurry near an inlet of a producer pipe of an artificial lift system;
transforming the reservoir data into at least a second solids concentration of a diluted dense slurry and a diluted slurry flow rate of the diluted dense slurry utilizing a computational solid-liquid slurry model; and
configuring at least one physical parameter of the artificial lift system using the second solids concentration and the diluted flow rate of the solid-liquid slurry.

2. The method of claim 1, further comprising:
building a fluid lift computational model configured to calculate:
i) at least one fluid and diluted dense slurry physical velocity in the producer pipe based on the diluted slurry flow rate of the diluted dense slurry and a lift fluid flow rate; and
ii) a slurry friction coefficient in the producer pipe based on a slurry rheology.

3. The method of claim 2, further comprising:
transforming the at least one fluid and diluted dense slurry physical velocity and the slurry friction coefficient into a pressure drop in the producer pipe using the fluid lift computational model; and
configuring at least one additional physical parameter of the artificial lift system using the pressure drop in the producer pipe.

4. The method of claim 3, further comprising:
providing a process for producing a slurry utilizing the artificial lift system, comprising:
(i) reducing a pressure at the producer pipe inlet to draw the dense slurry into the producer pipe, wherein the pressure is reduced using a jet pump directed towards the producer pipe inlet;
(ii) generating the diluted dense slurry using the jet pump;
(iii) flowing the diluted dense slurry into the producer pipe at the diluted slurry flow rate; and
(iv) lifting the diluted dense slurry through the producer pipe utilizing a fluid lift apparatus.

5. The method of claim 4, further comprising validating the fluid lift computational model using one of a volume of fluid (VOF) model and an Arbitrary Lagrangian Eulerian (ALE) model of fluid-slurry flow.

6. The method of claim 3, wherein the computational solid-liquid slurry model is configured to simultaneously determine a solids continuity equation, a fluids continuity equation, a solids momentum equation, and a fluids momentum equation for a transition from the in-situ solids concentration of the dense slurry to the second solids concentration of the diluted dense slurry.

7. The method of claim 6, wherein each of the solids and fluids momentum equations account for: a solid-liquid interaction expressed by drag force based on Darcy's law for the in-situ solids concentration of the dense slurry, a particle drag law for the second solids concentration of the diluted dense slurry, a solid-solid interaction stress expressed by a sum of friction and kinetic stresses in each of the dense slurry and the diluted dense slurry, and a turbulence model configured to account for additional momentum transfer due to turbulent fluctuations in each of the dense slurry and the diluted dense slurry.

8. The method of claim 7, wherein the pressure boundary condition of the subterranean formation is a radial pressure gradient near the producer pipe inlet.

9. The method of claim 8, wherein the computational solid-liquid slurry model is a numerical model including a computational fluid dynamics (CFD) model.

10. The method of claim 4, wherein the at least one physical parameter of the artificial lift system is selected from the group consisting of: a depth of the producer pipe inlet, a flow rate of the jet pump, a configuration of the jet pump, a distance between an injection well and the producer pipe inlet, and any combination thereof.

11. The method of claim 10, wherein the at least one additional physical parameter of the artificial lift system is selected from the group consisting of: an inner diameter of the producer pipe, a flow rate of the fluid lift apparatus, a configuration of the fluid lift apparatus, and any combination thereof.

12. The method of claim 4, wherein the method of producing a slurry further comprises a process selected from the group consisting of: a fluidized in-situ reservoir extraction (FIRE) process; a SRBR process; an enhanced CHOPS process; and any combination thereof.

13. The method of claim 4, wherein the dense slurry contains at least about forty volume percent sand concentration.

14. The method of claim 13, wherein the diluted dense slurry contains less than about forty volume percent sand concentration.

15. The method of claim 4, wherein the diluted dense slurry is produced at a rate of between about 400 cubic meters per day (m³/d) to about 3,000 m³/d.

16. The method of claim 10, wherein the diluted dense slurry is lifted at least about 250 feet through the producer pipe from the producer pipe inlet.

17. The method of claim 11, wherein the producer pipe has an inner diameter of from about 0.05 meters (m) to about 0.4 m.

18. The method of claim 4, wherein the diluted dense slurry is continuously produced for at least about 40 percent of the time for about 2 years.

19. The method of claim 10, wherein the distance between the injection well and the producer pipe inlet is from about 50 meters (m) to about 200 m.

20. The method of claim 10, wherein the jet pump configuration comprises at least one of an array of secondary spray nozzles to further dilute the dense slurry or the diluted dense slurry and an additional slurry dilution conduit to further dilute the diluted dense slurry inside the producer pipe.

21. The method of claim 11, the fluid lift apparatus further comprising a compressed fluid conduit, the jet pump apparatus further comprising a power fluid conduit, wherein the configuration of the fluid lift apparatus is selected from the group consisting of: the compressed fluid conduit adjacent to each of the producer pipe and the power fluid conduit, the compressed fluid conduit concentric with the producer pipe and adjacent to the power fluid conduit, the compressed fluid conduit concentric with the power fluid conduit and adjacent to the producer pipe, and the compressed fluid conduit concentric with each of the producer pipe and the power fluid conduit.

22. An artificial lift modeling method, comprising:
building a computational solid-liquid slurry model of a slurry production system in a subterranean formation having a dense slurry with an in-situ solids concentration and a pressure boundary condition near a producer pipe inlet, a producer pipe including the producer pipe inlet, a power fluid flow rate into the producer pipe through the producer pipe inlet configured to draw the dense slurry from the subsurface formation into the producer pipe at a slurry flow rate and mix the power fluid with the dense slurry to form a diluted dense slurry; and
determining at least a predicted diluted solids concentration of the diluted dense slurry and a predicted flow rate of the diluted dense slurry for a given power fluid flow rate using the computational solid-liquid slurry model.

23. The method of claim 22, further comprising:
building a lift fluid computational model based on the computational solid-liquid slurry model of the slurry production system, the lift fluid computational model including at least a lift fluid flow rate configured to transport the diluted dense slurry up the producer pipe at a production flow rate, wherein the lift fluid has a lower density than the diluted dense slurry and the lift fluid is injected at a location spaced from the producer pipe inlet; and
determining at least a predicted pressure drop in the producer pipe for a given lift fluid flow rate using the lift fluid computational model, the predicted diluted solids concentration of the diluted dense slurry, and the predicted flow rate of the diluted dense slurry from the computational solid-liquid slurry model.

24. The method of claim 23, wherein the pressure boundary condition near the producer pipe inlet is a radial pressure gradient near the producer pipe inlet.

25. The method of claim 24, further comprising one of a volume of fluid (VOF) model of fluid-slurry flow and an Arbitrary Lagrangian Eulerian (ALE) model of fluid-slurry flow configured to validate the fluid lift computational model.

26. The method of claim 24, further comprising:
exporting a result to a computing device, the result selected from the group consisting of: the predicted pressure drop in the producer pipe, the predicted diluted solids concentration of the diluted dense slurry, the predicted flow rate of the diluted dense slurry, and any combination thereof; and
using the result to configure a parameter of an artificial lift system selected from the group consisting of: a depth of the producer pipe inlet, a power fluid flow rate, a configuration of the jet pump, addition of in-well power fluid injection, a distance between an injection well and the producer pipe inlet, an inner diameter of the producer pipe, a lift fluid flow rate, a configuration of the lift fluid apparatus, and any combination thereof.

27. The method of claim 24, further comprising:
monitoring an active parameter to provide an active parameter real time value, the active parameter selected from the group consisting of: a measured pressure boundary condition; a measured pressure drop in the producer pipe; a measured flow rate of the diluted dense slurry; a measured power fluid flow rate; a measured lift fluid flow rate; and any combination thereof; and
adjusting at least one parameter selected from the group consisting of: the power fluid flow rate; the lift fluid flow rate; and any combination thereof using at least one active parameter real time value.

28. The method of claim 27, wherein the lift fluid computational model comprises:
i) at least one fluid and diluted dense slurry physical velocity in the producer pipe based on the diluted slurry flow rate of the diluted dense slurry and a lift fluid flow rate; and
ii) a slurry friction coefficient in the producer pipe based on a slurry rheology.

29. The method of claim 28, wherein the computational solid-liquid slurry model is configured to simultaneously determine a solids continuity equation, a fluids continuity equation, a solids momentum equation, and a fluids momentum equation for a transition from the in-situ solids concentration of the dense slurry to the predicted diluted solids concentration of the diluted dense slurry.

30. The method of claim 29, wherein each of the solids and fluids momentum equations account for: a solid-liquid interaction expressed by drag force based on Darcy's law for the in-situ solids concentration of the dense slurry, a particle drag law for the predicted diluted solids concentration of the diluted dense slurry, a solid-solid interaction stress expressed by a sum of friction and kinetic stresses in each of the dense slurry and the diluted dense slurry, and a turbulence model configured to account for additional momentum transfer due to turbulent fluctuations in each of the dense slurry and the diluted dense slurry.

31. The method of any one of claims 26-27, further comprising:
displaying an object on a visual output device, wherein the visual output device is operably connected to the computing device and the object is selected from the group consisting of: the result, the parameter of the artificial lift system, the active parameter real time value, and any combination thereof.

32. A method of controlling a slurry production process, comprising:
providing a method of producing a dense slurry from a subterranean formation, comprising:
injecting a power fluid at a power fluid flow rate into a producer pipe through a producer pipe inlet to draw the dense slurry into the producer pipe at a slurry flow rate using a jet pump directed towards the producer pipe inlet; and
obtaining a reservoir data set comprising at least a pressure boundary condition of the dense slurry in the subterranean formation and an in-situ solids concentration of the dense slurry in the subterranean formation;
calculating at least the slurry flow rate from the power fluid flow rate and the reservoir data set using a computational solid-liquid slurry model; and
controlling the slurry flow rate by adjusting the power fluid flow rate.

33. The method of claim 32, further comprising:
generating a diluted dense slurry having a diluted dense slurry density as a result of mixing the power fluid and the dense slurry and a lift fluid flow rate; and
injecting a lift fluid into the producer pipe having a lower density than the diluted dense slurry at a location spaced from the producer pipe inlet at a lift fluid flow rate configured to transport the slurry up the producer pipe at a production fluid flow rate.

34. The method of claim 33, further comprising:
calculating the production fluid flow rate from the lift fluid flow rate and the diluted dense slurry density using a lift fluid computational model; and
controlling the production fluid flow rate by adjusting the power fluid and lift fluid flow rates.

35. The method of claim 34, wherein the diluted dense slurry density is calculated using the computational solid-liquid slurry model.

36. The method of claim 34, wherein the pressure boundary condition of the dense slurry in the subterranean formation is a radial pressure gradient near the producer pipe inlet.

37. The method of claim 36, wherein the lift fluid is a gas selected from the group consisting of: air, carbon dioxide, nitrogen, argon, flue gas, and any combination thereof

38. A control system, comprising:
a reservoir data set comprising at least a pressure boundary condition of a subterranean formation and an in-situ solids concentration of a dense slurry near an inlet of a producer pipe of an artificial lift system, the artificial lift system comprising:
a) a well bore containing a producer pipe extending through an overburden below a surface of the earth into an oil sand reservoir, the producer pipe having an opening configured to permit the flow of a dense slurry into the producer pipe from the oil sand reservoir;
b) a jet pump incorporated into the well bore configured to inject a power fluid at a power fluid injection rate sufficient to generate a low pressure region around the opening of the producer pipe to draw the dense slurry from the oil sand reservoir into the producer pipe and dilute the dense slurry to form a diluted dense slurry; and
c) a slurry lift apparatus configured to lift the diluted dense slurry through the producer pipe towards the surface of the earth;
a computational solid-liquid slurry model configured to transform the reservoir data into at least a second solids concentration of a diluted dense slurry and a diluted slurry flow rate of the diluted dense slurry and a lift fluid flow rate; and
a set of instructions on a computer-readable medium configured to control at least the power fluid injection rate.

39. The system of claim 38, wherein the artificial lift system is configured to operate in an artificial lift process, the artificial lift process comprising:
(i) reducing a pressure at the producer pipe inlet to draw the dense slurry into the producer pipe, wherein the pressure is reduced using a jet pump directed towards the producer pipe inlet;
(ii) generating the diluted dense slurry using the jet pump;
(iii) flowing the diluted dense slurry into the producer pipe at the diluted slurry flow rate; and
(iv) lifting the diluted dense slurry through the producer pipe utilizing a fluid lift apparatus.

40. The system of claim 39, further comprising a fluid lift computational model configured to calculate:
i) at least one fluid and diluted dense slurry physical velocity in the producer pipe based on the diluted slurry flow rate of the diluted dense slurry and a lift fluid flow rate; and
ii) a slurry friction coefficient in the producer pipe based on a slurry rheology, wherein the fluid lift computational model is configured to transform the at least one fluid and diluted dense slurry physical velocity and the slurry friction coefficient into a pressure drop in the producer pipe.

41. The system of claim 40, wherein the set of instructions is further configured to provide:
at least one physical parameter of the artificial lift system using the second solids concentration and the diluted flow rate of the solid-liquid slurry; and
at least one additional physical parameter of the artificial lift system using the pressure drop in the producer pipe.

42. The system of claim 41, further comprising one of a volume of fluid (VOF) model of fluid-slurry flow and an Arbitrary Lagrangian Eulerian (ALE) model of fluid-slurry flow configured to validate the fluid lift computational model.

43. The system of claim 41, wherein the computational solid-liquid slurry model is a numerical model including a computational fluid dynamics (CFD) model.

44. The system of claim 41, wherein the at least one physical parameter of the artificial lift system is selected from the group consisting of: a depth of the producer pipe inlet, a flow rate of the jet pump, a configuration of the jet pump, a distance between an injection well and the producer pipe inlet, and any combination thereof; and
the at least one additional physical parameter of the artificial lift system is selected from the group consisting of: an inner diameter of the producer pipe, a flow rate of the fluid lift apparatus, a configuration of the fluid lift apparatus, and any combination thereof

45. The system of claim 38, wherein the artificial lift process further comprises a process selected from the group consisting of: a fluidized in-situ reservoir extraction (FIRE) process; a SRBR process; an enhanced CHOPS process; and any combination thereof
